(19) United States
(12) Patent Application Publication
(10) Pub. No.: US 2016/0028177 A1
(43) Pub. Date: Jan. 28, 2016

(54) ELECTRIC CONNECTION STRUCTURE AND TERMINAL

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, Fukuoka-shi, Fukuoka (JP)

(72) Inventors: Hideki NOMURA, Yokkaichi-shi (JP); Hiroki HIRAI, Yokkaichi-shi (JP); Junichi ONO, Yokkaichi-shi (JP); Takuji OOTSUKA, Yokkaichi-shi (JP); Tatsuya HASE, Yokkaichi-shi (JP); Kazuhiro GOTO, Osaka-shi (JP); Takehiro HOSOKAWA, Yokkaichi-shi (JP); Kazuo NAKASHIMA, Yokkaichi-shi (JP); Makoto MIZOGUCHI, Fukuoka-shi (JP)

(21) Appl. No.: 14/764,410

(22) PCT Filed: Jan. 28, 2014
(86) PCT No.: PCT/JP2014/051740

§ 371 Date: Jul. 29, 2015

(30) Foreign Application Priority Data
Feb. 18, 2013 (JP) 2013-029294
Apr. 5, 2013 (JP) 2013-079381

(51) Int. Cl. H01R 13/03; B32B 15/04; H01R 4/18; H01R 43/16; H01B 1/02

(52) U.S. Cl. CPC H01R 13/03; H01R 43/16; H01B 1/023; H01B 1/02; H01R 4/18; B32B 15/043; B32B 2250/02; B32B 2255/06; B32B 2255/24; B32B 2255/26; B32B 2307/73; B32B 2457/00

(57) ABSTRACT

An electric connection structure includes a copper member including copper or a copper alloy; a metal member connected to the copper member and including a metal having an ionization tendency greater than that of copper; and a surface treatment layer at least in a portion of the copper member that is different from a connection part connected to the metal member. The surface treatment layer includes a surface treating agent having a hydrophobic part and a chelate group in the molecular structure. Thus, the occurrence of electric erosion can be suppressed in the electric connection structure in which different kinds of metals are connected.

### TECHNICAL FIELD

The present invention relates to techniques associated with an electric connection structure between different kinds of metals.

### BACKGROUND ART

As an electric connection structure between different kinds of metals, the electric connection structure disclosed in Patent Document 1 is conventionally known. Patent Document 1 discloses techniques by which a copper terminal comprising copper or a copper alloy and an aluminum single core wire made of aluminum or an aluminum alloy are connected by cold welding. By the above configuration, the copper terminal and the aluminum single core wire are connected, through metal binding, on the cold-welded surface where the copper terminal and the aluminum single core wire are cold-welded. As a result of this, electric erosion of the aluminum single core wire on the cold-welded surface was expected to be suppressed.

### RELATED ART DOCUMENT

Patent Document

Patent Document 1: WO 2006/106971

### DISCLOSURE OF THE INVENTION

### Problem to be Solved by the Invention

According to the above configuration, however, there is fear that so-called corrosion current may flow when water 4 is deposited over both of a copper terminal 2 and an aluminum single core wire 3 in a portion that is different from a cold-welded surface 1, as shown in FIG. 13. This corrosion current will be explained below.

Firstly, in a portion of the aluminum single core wire 3 that is in contact with the water 4, aluminum releases electrons to the aluminum single core wire 3, and is eluted as Al³⁺ ions in the water. Thus, electrons are generated at the aluminum single core wire 3.

On the other hand, in a portion where the water 4 and copper terminal 2 are in contact with each other, oxygen dissolved in the water 4 (so-called, dissolved oxygen) accepts electrons from the copper terminal 2. Thus, H₂O is generated through a reaction among dissolved oxygen, H⁺ ions and electrons when the water 4 is acidic, or OH⁻ ions are generated through a reaction among dissolved oxygen, H₂O and electrons when the water 4 is neutral or alkaline. Electrons are consumed at the copper terminal 2 in this way.

The generation of electrons at the aluminum single core wire 3 and consumption thereof at the copper terminal 2 as described above result in the formation of a circuit via the water 4 between the aluminum single core wire 3 and the copper terminal 2, and corrosion current flows through this circuit. Thus, aluminum may be eluted into the water 4 by electric erosion in the portion where the water 4 and the aluminum single core wire 3 are in contact with each other.

The present invention has been completed based on the circumstances described above, and aims at providing techniques which are associated with an electric connection structure between different kinds of metals and suppress electric erosion.

### Means for Solving the Problem

The present invention relates to an electric connection structure including: a copper member including copper or a copper alloy; a metal member connected to the copper member and including a metal having an ionization tendency greater than that of copper; and a water-resistant layer formed at least in a portion of the copper member different from a connection part connected to the metal member.

According to the present invention, the water-resistant layer is formed in a portion of the copper member that is different from the connection part. This water-resistant layer can suppress arrival of water at the surface of the copper member. Thus, flow of corrosion current via water can be suppressed, thereby making it possible to improve the corrosion resistance of the metal member.

A preferred embodiment of the present invention is as follows.

The water-resistant layer may preferably be a surface treatment layer including a surface treating agent having a hydrophobic part and a chelate group in the molecular structure.

The surface treating agent contained in the above-described surface treatment layer has a chelate part in the molecular structure. This chelate part binds to the surface of the copper member, so that the surface treatment layer firmly binds to the copper member. On the other hand, the surface treating agent has a hydrophobic part in the molecular structure, and thus, when water is deposited over both of the copper member and the metal member, direct contact between the copper member and water is suppressed. Then, supply of dissolved oxygen contained in water to the copper member is suppressed. This configuration suppresses a reaction in which the dissolved oxygen accepts electron from the copper member, generates water or OH⁻ ions, and causes consumption of electrons. As a result of this, formation of a circuit via water between the copper member and the metal member is suppressed, thereby making it possible to suppress flow of corrosion current among the metal member, water and the copper member. According to the present invention, elution of the metal member by electric erosion can be suppressed by the configuration wherein the surface treatment layer is formed on the copper member connected to the metal member, not on the metal member.

The surface treating agent has a hydrophobic part having hydrophobicity in the molecular structure. The hydrophobic part has only to be hydrophobic at least in a portion of its molecular structure. The surface treating agent may include a hydrophobic group as the hydrophobic part. Also, the surface treating agent may include both of the hydrophobic part and a hydrophilic part in the molecular structure.

The hydrophobic part may preferably include an alkyl group.

According to the above-described aspect, direct contact between the copper member and water can reliably be suppressed. Examples of the alkyl group can include linear alkyl groups, branched alkyl groups and cycloalkyl groups. These may be used either singly or as a combination of two or more thereof. At this time, higher hydrophobicity is obtained if fluorine atoms are introduced, for example, into linear alkyl groups, branched alkyl groups or cycloalkyl groups.

The above-described chelate group may preferably be derived from one chelate ligand or two or more chelate ligands selected from polyphosphate, amino carboxylic acid, 1,3-diketone, acetoacetic acid (ester), hydroxycarboxylic acid, polyamine, amino alcohol, aromatic heterocyclic bases, phenols, oximes, Schiff bases, tetrapyrroles, sulfur compounds, synthetic macrocyclic compounds, phosphonic acid and hydroxyethylidenephosphonic acid.

The chelate group is composed of the above-described various groups and can thus reliably bind to the surface of the copper member.

The surface treating agent may preferably include a benzotriazole derivative of the following general formula (1) having the chelate group which is derived from the aromatic heterocyclic base in the molecular structure:

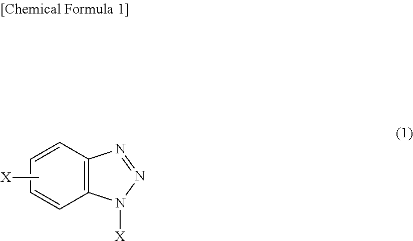

wherein X represents a hydrophobic group; and Y represents a hydrogen atom or a lower alkyl group.

According to the above-described aspect, the benzotriazole derivative includes a hydrophobic group, and thus deposition of water on the surface of the copper member can be suppressed. Further, arrival of the dissolved oxygen in water at the surface of the copper member can be suppressed. Thus, flow of corrosion current can further be suppressed, so that electric erosion of the metal member can further be suppressed.

The hydrophobic group represented by the above-described X may preferably be represented by the following general formula (2):

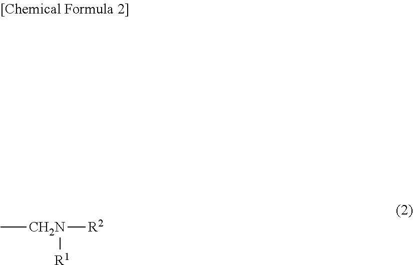

wherein R¹ and R² each independently represent a hydrogen atom or an alkyl group having 1 to 15 carbon atoms, a vinyl group, an allyl group or an aryl group.

Preferably, the R¹ and the R² each independently may represent a linear alkyl group, a branched alkyl group or a cycloalkyl group having 5 to 11 carbon atoms.

According to the above-described aspect, the number of the carbon atoms in the hydrophobic group represented by X is relatively great, leading to high hydrophobicity. Thus, flow of corrosion current can further be suppressed, thereby making it possible to further suppress electric erosion of the metal member.

The linear alkyl group, a branched alkyl group or a cycloalkyl group may include, for example, a carbon-carbon unsaturated bond, an amide bond, an ether bond or an ester bond. The cycloalkyl group may also be formed either from a single ring or from a plurality of rings.

The above-described Y may preferably be a hydrogen atom or a methyl group.

According to the above-described aspect, the hydrophobicity of the surface treatment layer is improved, so that electric erosion of the metal member can further be suppressed.

The above-described metal member may preferably include aluminum or an aluminum alloy.

According to the above-described aspect, the electric connection structure can be reduced in weight because aluminum or an aluminum alloy has a relatively small specific weight.

Preferably, the above-described copper member may be a first core wire of a first wire, and the above-described metal member may be a second core wire of a second wire which is different from the first wire.

According to the above-described aspect, it is possible to suppress elution, by electric erosion, of the metal member which constitutes the second core wire of the second wire at the time of electric connection between the first and second wires.

Preferably, the above-described metal member may be a core wire of a wire, the above-described copper member may be a terminal having a wire barrel part to be crimped to the above-described core wire, and the above-described surface treatment layer may be formed at least on an end surface of the above-described wire barrel part.

The terminal is formed by pressing a metal plate material into a predetermined shape. Therefore, copper or a copper alloy which constitutes the metal plate material is exposed on the end surface of the wire barrel part after pressing, regardless of whether the metal plate material is plated or not. In the state where copper or a copper alloy is exposed on the end surface of the wire barrel part, water is deposited here, and thus electric erosion may be promoted due to the difference in ionization tendency from aluminum or an aluminum alloy contained in the core wire, leading to the elution of aluminum from the core wire.

In light of this, the surface treatment layer is formed on the end surface of the wire barrel part in the above-described aspect, and thus no copper or copper alloy is exposed on the end surface of the wire barrel part. Thus, electric erosion of the core wire can be prevented.

Also, the present invention relates to a terminal using the above-described electric connection structure. The terminal is formed of a metal plate material in which the above-described copper member and the above-described metal member are cold-welded, and has a copper region including the above-described copper member and a metal region including the above-described metal member, which regions are aligned in juxtaposition, and the above-described surface treatment layer is formed in the above-described copper region.

According to the present invention, corrosion of the metal member by electric erosion can be suppressed for the terminal in which the copper member and the metal member are cold-welded to be integrally formed.

A preferred embodiment of the present invention is as follows. Preferably, the above-described copper region may have a plated region which is plated with a plating metal having an ionization tendency that is closer to that of the above-described copper member than to that of the above-described metal member, and the above-described surface treatment layer may be formed at least in a region of the above-described copper member where the plated region is not formed.

According to the above-described aspect, the differences in ionization tendency between the metal region and the plated region and between the copper region and the plated region are smaller than that between the metal region and the copper region. Thus, electric erosion is less likely to occur, thereby suppressing the electric erosion speed.

Preferably, the above-described metal member may include aluminum or an aluminum alloy, and the above-described metal region may include an alumite layer on a surface thereof.

According to the above-described aspect, since the alumite layer is formed on the surface of the metal region, the elution of aluminum into water is suppressed. Thus, the corrosion of the metal member by electric erosion can further be suppressed.

The above-described water resistant layer may preferably include a basic compound having an affinity group with affinity for the above-described copper member and a basic group; and an acidic compound having an acidic group to be reacted with the above-described basic group and a hydrophobic group.

According to the above-described aspect, since the water resistant layer has a hydrophobic group, the water on the water resistant layer is less likely to reach the copper member. Thus, flow of corrosion current via water can be suppressed, thereby making it possible to improve the corrosion resistance of the metal member.

Also, since the affinity group contained in the water resistant layer has affinity for the copper member, the basic compound can reliably be bound to the surface of the copper member. Since the basic group of this basic compound reacts with the acidic group of the acidic compound, the basic compound and the acidic compound are firmly bound together. Thus, the hydrophobic group contained in the acidic compound is firmly bound to the copper member via the basic compound. In this way, the present invention enables firm binding between the copper member and the water resistant layer, so that the separation of the water resistant layer from the copper member can be suppressed. As a result, the corrosion resistance of the metal member can be improved.

The above-described water resistant layer may preferably cover a portion of the above-described copper member that is different from the above-described connection part.

According to the above-described aspect, the deposition of water on the surface of the copper member can reliably be suppressed, thereby making it possible to reliably improve the corrosion resistance of the metal member.

Preferably, the above-described copper member may have a plated layer which is plated with a plating metal having an ionization tendency that is closer to that of the above-described copper member than to that of the above-described metal member, and the above-described water resistant layer may be formed at least in a region of the above-described copper member where the above-described plated layer is not formed.

According to the above-described aspect, the differences in ionization tendency between the metal member and the plated layer and between the copper member and the plated layer are smaller than that between the metal member and the copper member. Thus, electric erosion is less likely to occur, thereby improving the electric erosion resistance.

The affinity group may preferably be a nitrogen-containing heterocyclic group.

According to the above-described aspect, since the nitrogen-containing heterocyclic group has basicity, elution of the copper member or metal member through a reaction with the affinity group can be suppressed when the affinity group has acidity.

Preferably, the above-described nitrogen-containing heterocyclic group may serve also as the basic group. According to the above-described aspect, the structure of the basic compound can be simplified as compared with the case where the basic compound has a basic functional group in addition to the nitrogen-containing heterocyclic group.

The above-described basic compound may preferably be a compound represented by the following general formula (3):

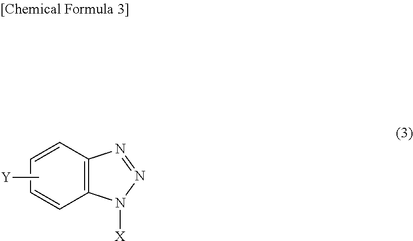

wherein X represents a hydrogen atom or an organic group; and Y represents a hydrogen atom or a lower alkyl group.

According to the above-described aspect, a dense layer of the basic compound can be formed on the surface of the copper member. Thus, the deposition of water on the surface of the copper member can reliably be suppressed.

The above-described X may preferably be an amino group represented by the following general formula (4):

[Chemical Formula 4]

—R—NH₂ (4)

wherein R represents an alkyl group having 1 to 3 carbon atoms.

According to the above-described aspect, the amino group of the X and the acidic compound can be reacted with each other.

The above-described basic compound may preferably be a benzotriazole represented by formula (5):

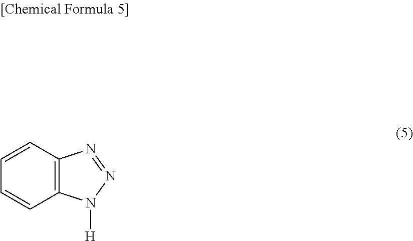

Since a simple structure of the basic compound can be realized according to the above-described aspect, a dense layer of the basic compound can be formed on the surface of the copper member. Thus, the deposition of water on the surface of the copper member can reliably be suppressed.

The above-described acidic group may preferably include one group or two or more groups selected from the group consisting of a carboxyl group, a phosphate group, a phosphonic acid group and a sulfonyl group.

According to the above-described aspect, the basic compound and the acidic compound can reliably be reacted with each other.

The above-described hydrophobic group may preferably be an organic group having at least 3 carbon atoms.

The above-described aspect makes it possible to reliably suppress arrival of water on the surface of the copper member.

The above-described metal member may preferably include aluminum or an aluminum alloy.

According to the above-described aspect, the weight of the electric connection structure can be reduced because aluminum or an aluminum alloy has a relatively small specific weight.

Also, the present invention is directed to a terminal employing the electric connection structure. The terminal is made of the above-described copper member and is connected to a core wire of a wire, the core wire being made of the above-described metal member.

According to the above-described aspect, the corrosion resistance of the terminal to be connected to a wire can be improved.

### Effect of the Invention

According to the present invention, the electric erosion resistance of the electric connection structure can be improved.

### BRIEF DESCRIPTION OF THE DRAWINGS

FIG. 1 is an enlarged cross sectional view showing an electric connection structure according to a first embodiment (1) of the present invention.

FIG. 2 is a perspective view showing a state where a copper member and a metal member are superposed on each other.

FIG. 3 is an enlarged cross sectional view showing a state where the copper member and the metal member are nipped between a pair of jigs.

FIG. 4 is an enlarged cross sectional view showing the electric connection structure.

FIG. 5 is a schematic diagram showing a model experimental apparatus.

FIG. 6 is a side view showing a terminal according to a first embodiment (2) of the present invention.

FIG. 7 is a partial plan view showing a metal plate material which has been subjected to punching.

FIG. 8 is an enlarged cross sectional view showing the metal plate material before formation of a plated region.

FIG. 9 is a partial plan view showing the metal plate material after formation of the plated region.

FIG. 10 is a side view showing a wire with a terminal according to a first embodiment (3) of the present invention.

FIG. 11 is an enlarged plan view showing the wire with a terminal.

FIG. 12 is a plan view showing an electric connection structure according to a first embodiment (4) of the present invention.

FIG. 13 is a schematic diagram showing a conventional technique.

FIG. 14 is an enlarged cross sectional view showing an electric connection structure according to a second embodiment (1) of the present invention.

FIG. 15 is a perspective view showing a state where a copper member and a metal member are superposed on each other.

FIG. 16 is an enlarged cross sectional view showing a state where the copper member and the metal member are nipped between a pair of jigs.

FIG. 17 is an enlarged cross sectional view showing the electric connection structure.

FIG. 18 is a side view showing a wire with a terminal according to a second embodiment (2) of the present invention.

FIG. 19 is an enlarged plan view showing the wire with a terminal.

FIG. 20 is a graph showing electric resistance values between a core wire and a wire barrel part before and after a salt spray test.

FIG. 21 is a graph showing the results of a tensile test on the wire with a terminal before and after the salt spray test.

FIG. 22 is a plan view showing an electric connection structure according to a second embodiment (3) of the present invention.

### MODE FOR CARRYING OUT THE INVENTION

### First Embodiment (1)

A first embodiment (1) according to the present invention will be explained with reference to FIGS. 1 to 5. The present embodiment is an electric connection structure 30 including a copper member 10 and a metal member 11 including a metal having an ionization tendency greater than that of copper.

(Metal Member 11)

The metal member 11 includes a metal having an ionization tendency greater than that of copper, as shown in FIG. 1. Examples of the metal contained in the metal member 11 can include magnesium, aluminum, manganese, zinc, chromium, iron, cadmium, cobalt, nickel, tin and lead or alloys thereof. In the present embodiment, the metal member 11 is obtained by pressing a plate material including aluminum or an aluminum alloy into a predetermined form.

(Copper Member 10)

The copper member 10 includes copper or a copper alloy. In the present embodiment, the copper member 10 is obtained by pressing a plate material including copper or a copper alloy into a predetermined form.

(Connection Structure)

As a method for connecting the metal member 11 and the copper member 10, any connection method such as resistance welding, ultrasonic welding, brazing connection (including brazing and soldering), cold welding, welding or bolting can be appropriately selected according to need. In the present embodiment, the metal member 11 and the copper member 10 are welded by being nipped between a pair of jigs 14. In a connection part 12 where the metal member 11 and the copper member 10 are connected by welding, the metal member 11 and the copper member 10 are electrically connected to each other.

(Surface Treatment Layer 13)

A surface treatment layer (corresponding to the water resistant layer) 13 to which a surface treating agent is applied is formed in a portion of the copper member 10 different from the connection part 12. The surface treatment layer 13 is formed in a portion of the surface of the copper member 10 different from the connection part 12 which is in contact with the metal member 11. The surface of the copper member 10 refers to all the surfaces of the copper member 10 that are exposed to the outside, for example, the upper, lower and side surfaces thereof.

The surface treatment layer 13 is formed at least on the copper member 10. This surface treatment layer 13 may be formed in a portion of the surface of the metal member 11 different from the portion which is in contact with the copper member 10. In the meantime, the surface treatment layer 13 may be formed on the surfaces of the metal member 11 (upper, lower and side surfaces).

The surface treating agent includes a chelate group in the molecular structure. The chelate group binds to the surface of the copper member 10. Due to the binding of the chelate group to the surface of the copper member 10, the separation of the surface treating agent from the surface of the copper member 10, e.g., volatilization of the surface treating agent by heating or elution of the surface treating agent by means of a solvent, is suppressed. Thus, the surface treatment layer 13 is formed on the surface of the copper member 10 stably over a long period. It can be confirmed that the chelate group forms a binding to the surface of the copper member 10 to be changed to a chelate bond, for example, by a multiple total reflection infrared absorption method (ATR-IR) or microscopic IR.

The surface treating agent includes a hydrophobic part in the molecular structure. The hydrophobic part has only to be hydrophobic at least in a part of its molecular structure. The surface treating agent may include a hydrophobic group as the hydrophobic part. Also, the surface treating agent may include both of the hydrophobic part and a hydrophilic part in the molecular structure. The surface treating agent can suppress the invasion of water into the surface of the copper member 10 due to the hydrophobicity of the hydrophobic part. Specifically, not only the surface of the copper member 10 is merely physically covered with the surface treatment layer 13 formed on the surface of the copper member 10, but also the invasion of water into the surface of the copper member 10 can be suppressed due to the hydrophobicity of the hydrophobic part.

The chelate group can be introduced by using various chelate ligands. Examples of such a chelate ligand can include β-dicarbonyl compounds such as 1,3-diketones (β-diketones) and 3-ketocarboxylic acid esters (acetoacetic acid esters), polyphosphates, aminocarboxylic acid, hydroxycarboxylic acid, polyamines, amino alcohols, aromatic heterocyclic bases, phenols, oximes, Schiff bases, tetrapyrroles, sulfur compounds, synthetic macrocyclic compounds, phosphonic acid and hydroxyethylidenephosphonic acid. These compounds have a plurality of unshared electron pairs that can form a coordinate bond. These may be used singly, or two or more thereof may be used in combination.

More specifically, examples of various chelate ligands can include polyphosphates such as sodium tripolyphosphate and hexametaphosphoric acid. Examples of the aminocarboxylic acid can include ethylenediamine diacetic acid, ethylenediamine dipropionic acid, ethylenediamine tetraacetic acid, N-hydroxymethylethylenediamine triacetic acid, N-hydroxyethylethylenediamine triacetic acid, diaminocyclohexyl tetraacetic acid, diethylenetriamine pentaacetic acid, glycoletherdiamine tetraacetic acid, N,N-bis(2-hydroxybenzyl)ethylenediamine diacetic acid, hexamethylenediamine N,N,N,N-tetraacetic acid, hydroxyethylimino diacetic acid, imino diacetic acid, diaminopropane tetraacetic acid, nitrilo triacetic acid, nitrilo tripropionic acid, triethylenetetramine hexaacetic acid, and poly(p-vinylbenzylimino diacetic acid).

Examples of the 1,3-diketone can include acetylacetone, trifluoroacetylacetone and thenoyltrifluoroacetone. In addition, examples of the acetoacetic acid esters can include acetoacetic acid propyl, acetoacetic acid tert-butyl, acetoacetic acid isobutyl, and acetoacetic acid hydroxypropyl. Examples of the hydroxycarboxylic acid can include N-dihydroxyethylglycine, ethylene bis(hydroxyphenylglycine), diaminopropanol tetraacetic acid, tartaric acid, citric acid, and gluconic acid. Examples of the polyamines can include ethylenediamine, triethylenetetramine, triaminotriethylamine, and polyethyleneimine. Examples of the amino alcohols can include triethanolamine, N-hydroxyethylethylenediamine, and polymetharyloylacetone.

Examples of the aromatic heterocyclic bases can include dipyridyl, o-phenanthroline, oxine, 8-hydroxyquino line, benzotriazole, benzoimidazole and benzothiazole. Examples of the phenols can include 5-sulfosalicylic acid, salicylaldehyde, disulfopyrocatecol, chromotropic acid, oxysulfonic acid and disalicylaldehyde. Examples of the oximes can include dimethylglyoxime and salicylaldoxime. Examples of the Schiff bases can include dimethylglyoxime, salicylaldoxime, disalicylaldehyde and 1,2-propylenediimine.

Examples of the tetrapyrroles can include phthalocyanine and tetraphenylporphyrin. Examples of the sulfur compounds can include toluenedithiol, dimercaptopropanol, thioglycolic acid, potassium ethylxanthogenate, sodium diethyldithiocarbamate, dithizone and diethyldithiophosphoric acid. Examples of the synthetic macrocyclic compounds can include tetraphenylporphyrin and crown ethers. Examples of the phosphonic acid can include ethylenediamine N,N-bismethylene phosphonic acid, ethylenediamine tetrakis methylenephosphonic acid, nitrilotris methylene phosphonic acid and hydroxyethylidene diphosphonic acid.

A hydroxyl group, an amino group or the like may also be appropriately introduced to the above-described chelate ligand. Some of the above-described chelate ligands can be present in the form of salt. In this case, they may be used in the form of salt. In addition, a hydrate or solvate of the chelate ligand or the salt thereof may be used. In addition, the above-described chelate ligand, which includes an optical active material, may include any stereoisomer, a mixture of stereoisomers, or a racemic form.

The surface treating agent may be configured to include either one or both of a benzotriazole and a benzotriazole derivative. The benzotriazole derivative is represented by the following general formula (1):

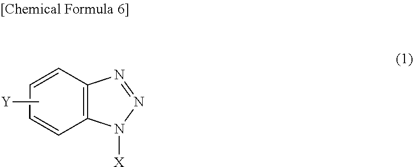

wherein X represents a hydrophobic group; and Y represents a hydrogen atom or a lower alkyl group.

In the benzotriazole derivative represented by the general formula (1), the chelate group is derived from a benzotriazole. Also, the hydrophobic part includes a hydrophobic group represented by X and an aromatic six-membered ring bound to a triazole. The hydrophobic group represented by X is arranged so as to project outward from the chelate group which forms a binding to the metal surface.

The above-described hydrophobic group represented by X includes an organic group. Examples of the organic group include linear or branched alkyl groups, vinyl groups, allyl groups, cycloalkyl groups and aryl groups. These may be used singly or as a combination of two or more thereof. At this time, if a fluorine atom is introduced, for example, into the linear or branched alkyl group, vinyl group, allyl group, cycloalkyl group, aryl group or the like, higher hydrophobicity is obtained. The hydrophobic group may include an amide bond, an ether bond or an ester bond.

The above-described hydrophobic group represented by X is represented by the following general formula (2):

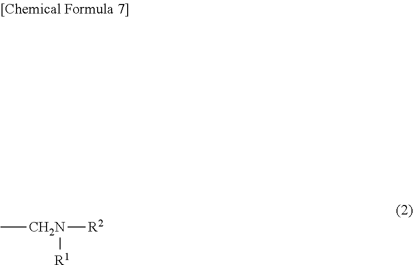

wherein R¹ and R² each independently represent a hydrogen atom or an alkyl group having 1 to 15 carbon atoms, a vinyl group, an allyl group or an aryl group.

Examples of the alkyl group can include a linear alkyl group, a branched alkyl group or a cycloalkyl group.

Examples of the linear alkyl group include a methyl group, an ethyl group, a propyl group, a butyl group, a propyl group, a pentyl group, a hexyl group, a heptyl group, an octyl group, a nonyl group, a decyl group, an undecyl group, a dodecyl group, a tridecyl group, a tetradecyl group and a pentadecyl group. The number of carbon atoms of the linear alkyl group preferably ranges from 1 to 100, more preferably ranges from 3 to 15, further preferably ranges from 5 to 11, especially preferably ranges from 7 to 9.

Examples of the branched alkyl group include an isopropyl group, a 1-methylpropyl group, a 2-methylpropyl group, a tert-butyl group, a 1-methylbutyl group, a 2-methylbutyl group, 3-methylbutyl group, a 1,1-dimethylpropyl group, a 1,2-dimethylpropyl group, a 2,2-dimethylpropyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 5-methylhexyl group, a 6-methylheptyl group, a 2-methylhexyl group, a 2-ethylhexyl group, a 2-methylheptyl group and a 2-ethylheptyl group. The number of carbon atoms of the branched alkyl group preferably ranges from 1 to 100, more preferably ranges from 3 to 15, further preferably ranges from 5 to 11, especially preferably ranges from 7 to 9.

Examples of the cycloalkyl group include a cyclopropyl group, a cyclobutyl group, a cyclopentyl group, a methylcyclopentyl group, a dimethylcyclopentyl group, a cyclopentylmethyl group, a cylopentylethyl group, a cylohexyl group, a methylcyclohexyl group, a dimethylcyclohexyl group, a cylohexylmethyl group and a cyclohexylethyl group. The number of carbon atoms of the cycloalkyl group preferably ranges from 3 to 100, more preferably ranges from 3 to 15, further preferably ranges from 5 to 11, especially preferably ranges from 7 to 9.

Examples of the aryl group include a phenyl group, a 1-naphtyl group, a 2-naphtyl group, a 2-phenylphenyl group, a 3-phenylphenyl group, a 4-phenylphenyl group, a 9-anthryl group, a methylphenyl group, a dimethylphenyl group, a trimethylphenyl group, an ethylphenyl group, a methylethylphenyl group, a diethylphenyl group, a propylphenyl group and a butylphenyl group. The number of carbon atoms of the aryl group preferably ranges from 6 to 100, more preferably ranges from 6 to 15, further preferably ranges from 6 to 11, especially preferably ranges from 7 to 9.

The above-described linear alkyl group can be introduced by using a linear alkyl compound. Examples of the linear alkyl compound can include, but are not limited to, linear alkyl carboxylic acid, linear alkyl carboxylic acid derivatives such as linear alkyl carboxylic acid ester and linear alkyl carboxylic acid amide, linear alkyl alcohols, linear alkyl thiols, linear alkyl aldehydes, linear alkyl ethers, linear alkyl amines, linear alkyl amine derivatives linear alkyl halogen. Among these, linear alkyl carboxylic acid, linear alkyl carboxylic acid derivatives, linear alkyl alcohols and linear alkyl amines are preferable, for example, from the view point of easiness to introduce a chelate group.

More specific examples of the linear alkyl compound can include octanoic acid, nonanoic acid, decanoic acid, hexadecanoic acid, octadecanoic acid, icosanoic acid, docosanoic acid, tetradocosanoic acid, hexadocosanoic acid, octadocosanoic acid, octanol, nonanol, decanol, dodecanol, hexadecanol, octadecanol, eicosanol, docosanol, tetradocosanol, hexadocosanol, octadocosanol, octylamine, nonylamine, decylamine, dodecylamine, hexadecylamine, octadecylamine, dodecylcarboxylic acid chloride, hexadecylcarboxylic acid chloride and octadecylcarboxylic acid chloride. Among these, octanoic acid, nonanoic acid, decanoic acid, dodecanoic acid, octadecanoic acid, docosanoic acid, octanol, nonanol, decanol, dodecanol, octadecanol, docosanol, octylamine, nonylamine, decylamine, dodecylamine, octadecylamine, dodecylcarboxylic acid chloride and octadecylcarboxylic acid chloride are suitable, for example, from the viewpoint of easiness to obtain.

The above-described cycloalkyl group can be introduced by using a cyclic alkyl compound. Examples of the cyclic alkyl compound can include, but are not limited to, a cycloalkyl compound having 3 to 8 carbon atoms, a compound having a steroid skeleton and a compound having an adamantane skeleton. At this time, a carboxylic acid group, a hydroxyl group, an acid amide group, an amino group, a thiol group or the like can preferably be introduced into these various compounds, for example, from the viewpoint of the fact that they can form a binding to the above-described chelate ligand.

More specific examples of the cyclic alkyl compounds can include cholic acid, deoxycholic acid, adamantane carboxylic acid, adamantane acetic acid, cyclohexyl cyclohexanol, cyclopentadecanol, isoborneol, adamantanol, methyl adamantanol, ethyl adamantanol, cholesterol, cholestanol, cyclooctylamine, cyclododecylamine, adamantane methylamine and adamantane ethylamine. Among these, adamantanol and cholesterol are suitable, for example, from the viewpoint of easiness to obtain.

Also, the above-described Y is preferably a hydrogen atom or a lower alkyl group, further preferably a methyl group.

The surface treating agent can be configured to include one compound or a plurality of compounds selected from the group consisting of benzotriazoles and the above-described plurality of benzotriazole derivatives.

The surface treating agent may also be configured to be dissolved in a known solvent. As the solvent, water, an organic solvent, wax, oil or the like can be used. Examples of the organic solvent include aliphatic solvents such as n-hexane, isohexane and n-heptane; ester-based solvents such as ethyl acetate and butyl acetate; ether-based solvents such as tetrahydrofuran; ketone-based solvents such as acetone; aromatic solvents such as toluene and xylene; and alcoholic solvents such as methanol, ethanol, propyl alcohol and isopropyl alcohol. Also, examples of the Wax can include polyethylene wax, synthetic paraffin, natural paraffin, microwax and chlorinated hydrocarbons. Also, examples of the oil can include lubricant oil, hydraulic oil, heat transfer oil and silicone oil.

As a method for applying the surface treating agent to the copper member 10, there may be used any method of immersing the copper member 10 in the surface treating agent, applying the surface treating agent to the copper member 10 with a brush, spraying the surface treating agent or a solution obtained by dissolving the surface treating agent in a solvent to the copper member 10, or mixing the surface treating agent in a press oil for use when pressing the copper member 10. It is also possible to control the amount of the surface treating agent to be applied by air knife method or roll drawing method and to make the appearance and film thickness uniform after the application treatment with a squeeze coater, immersion treatment or spraying treatment. When the surface treating agent is applied, treatment such as warming or compression can be applied according to need in order to improve the adhesiveness and corrosion resistance.

(Production Steps)

Next, one example of the production steps according to the present embodiment will be indicated. In the meantime, the production steps are not limited to those described below.

First, a copper member 10 is formed by pressing a plate material including a copper alloy into a predetermined shape. Next, a metal member 11 is formed by pressing a plate material including an aluminum alloy into a predetermined shape.

Then, the copper member 10 is immersed in the surface treating agent, and thereafter air-dried at room temperature, thereby forming a surface treatment layer 13 on the surface of the copper member 10.

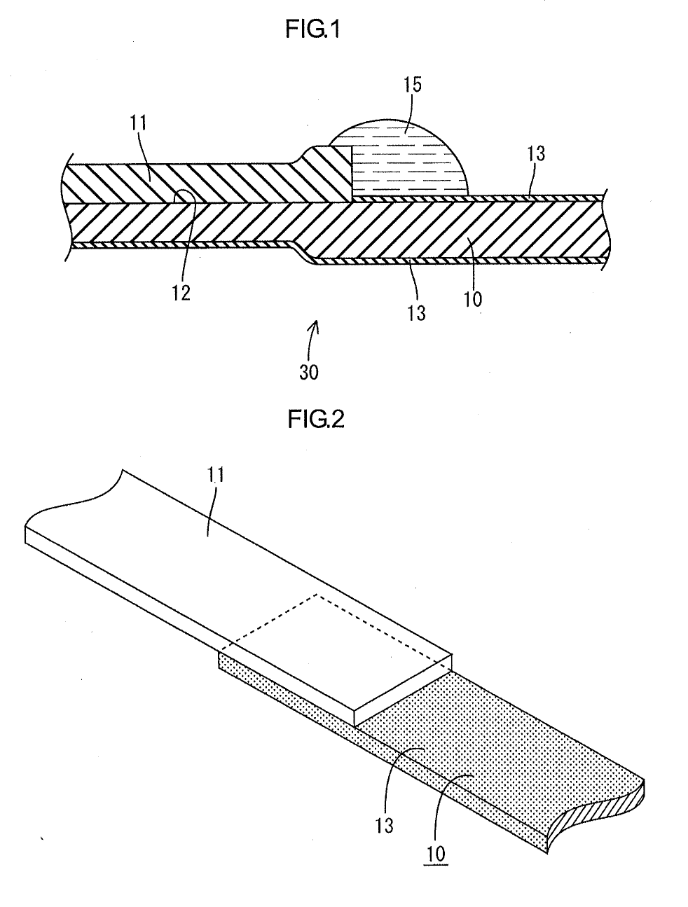

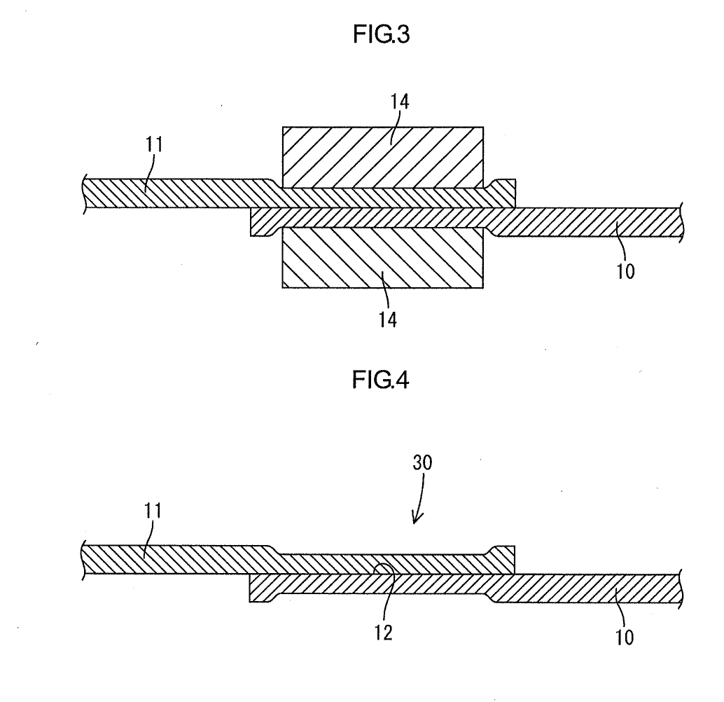

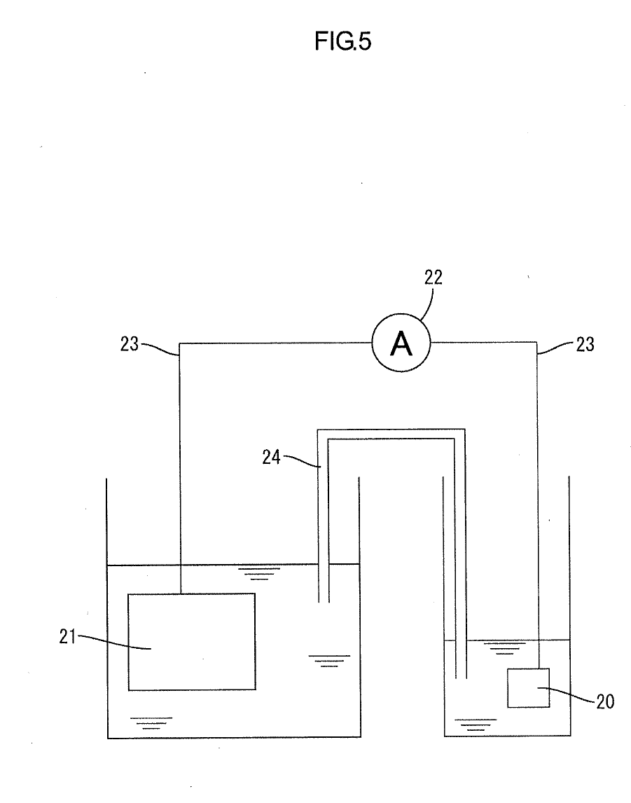

Subsequently, the copper member 10 and the metal member 11 are laminated as shown in FIG. 2, and then nipped between a pair of jigs 14 as shown in FIG. 3, thereby welding the copper member 10 and the metal member 11. In FIG. 2, the surface treatment layer 13 is shown in a hatched manner. This allows for electric connection between the copper member 10 and the metal member 11 (see FIG. 4). At this time, in the connection part 12 where the copper member 10 and the metal member 11 are connected, high pressure is applied by the jigs 14, so that the surface treating agent is eliminated from the connection part 12. Thus, the surface treatment layer 13 is not interposed between the copper member 10 and the metal member 11, thereby improving the reliability of electric connection between the copper member 10 and the metal member 11.

(Action/Effect of the Present Embodiment)

Next, the action/effect of the present embodiment will be explained. As shown in FIG. 1, in the electric connection structure 30 according to the present embodiment, the surface treatment layer 13 is formed at least in a portion of the surface of the copper member 10 (all the surfaces that are exposed to the outside, including the upper, lower and side surfaces) different from the connection part 12 connected to the metal member 11. Thus, when water 15 is deposited over both of the copper member 10 and the metal member 11, direct contact between the copper member 10 and the water 15 is suppressed by the surface treatment layer 13 formed on the copper member 10.

Since the surface treatment layer 13 is not formed in the connection part 12 according to the present embodiment, the deterioration in reliability of electric connection between the copper member 10 and the metal member 11 can be suppressed.

Also, according to the present embodiment, the surface treating agent which constitutes the surface treatment layer 13 has a chelate part in the molecular structure. This chelate part binds to the surface of the copper member 10, so that the surface treatment layer 13 firmly binds to the copper member 10. On the other hand, since the surface treating agent has a hydrophobic part in the molecular structure, direct contact between the copper member 10 and water is suppressed when water is deposited over both of the copper member 10 and the metal member 11. Then, the supply of the dissolved oxygen contained in the water 15 to the copper member 10 is suppressed. This configuration suppresses a reaction in which the dissolved oxygen accepts electrons from the copper member 10, generates H₂O or OH⁻ ions, and causes consumption of electrons. As a result of this, formation of a circuit via the water 15 between the copper member 10 and the metal member 11 is suppressed, thereby making it possible to suppress flow of corrosion current among the metal member 11, water 15 and the copper member 10. According to the present embodiment, elution of the metal member 11 by electric erosion can be suppressed by the configuration wherein the surface treatment layer 13 is formed on the copper member 10 connected to the metal member 11, not on the metal member 11.

The surface treating agent according to the present embodiment has a hydrophobic part having hydrophobicity in the molecular structure. The hydrophobic part has only to be hydrophobic at least in a part of its molecular structure. The surface treating agent may include a hydrophobic group as the hydrophobic part. Also, the surface treating agent may include both of the hydrophobic part and a hydrophilic part in the molecular structure. According to the present embodiment, the hydrophobic part can reliably suppress direct contact between the copper member 10 and the water 15.

The chelate group according to the present embodiment is preferably derived from one chelate ligand or two or more chelate ligands selected from polyphosphate, amino carboxylic acid, 1,3-diketone, acetoacetic acid (ester), hydroxycarboxylic acid, polyamine, amino alcohol, aromatic heterocyclic bases, phenols, oximes, Schiff bases, tetrapyrroles, sulfur compounds, synthetic macrocyclic compounds, phosphonic acid and hydroxyethylidene phosphonic acid. The chelate group is composed of any of the above-described various groups, and thus can reliably bind to the surface of the copper member.

Also, the surface treating agent according to the present embodiment can be configured to include a benzotriazole derivative represented by the following general formula (1):

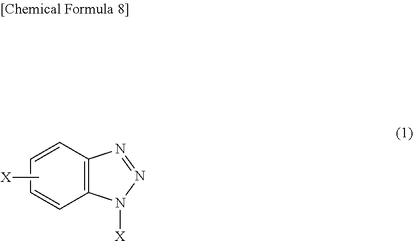

wherein X represents a hydrophobic group; and Y represents a hydrogen atom or a lower alkyl group.

According to the present embodiment, the benzotriazole derivative includes a hydrophobic group, and thus the deposition of the water 15 on the surface of the copper member 10 can be suppressed. Further, the arrival of the dissolved oxygen contained in water at the surface of the copper member 10 can be suppressed. Thus, flow of corrosion current can further be suppressed, whereby the electric erosion of the metal member 11 can further be suppressed.

The above-described hydrophobic group represented by X can be configured to be represented by the following general formula (2):

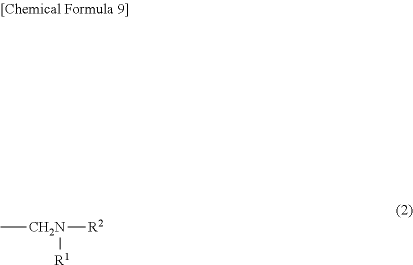

wherein R¹ and R² each independently represent a hydrogen atom or an alkyl group having 1 to 15 carbon atoms, a vinyl group, an allyl group or an aryl group.

According to the present embodiment, the benzotriazole derivative can be relatively easily synthesized.

The above-described R¹ and R² can be each independently a linear alkyl group, a branched alkyl group or a cycloalkyl group having 5 to 11 carbon atoms. Thus, the number of carbon atoms of the hydrophobic group represented by X becomes relatively large, resulting in high hydrophobicity. Due to this, flow of corrosion current can further be suppressed, and thus the electric erosion of the metal member 11 can further be suppressed.

Also, in the present embodiment, the metal member 11 includes aluminum or an aluminum alloy. The electric connection structure 30 can be reduced in weight because aluminum or an aluminum alloy has a relatively small specific weight.

(Test 1 for Evaluation of Corrosion Current)

Next, a model experiment on the electric connection structure of the present invention will be explained. By this model experiment, it has been acknowledged that corrosion current is suppressed by formation of the surface treatment layer on the copper member.

### Test Example 1

First, a test piece 1 cm in width and 1 cm in length was formed as a metal member 20 by pressing an aluminum plate having a thickness of 0.2 mm. The metal member 20 was immersed in an aqueous solution of 5% by mass NaOH for 1 minute, then immersed in 50% HNO₃ for 1 minute, and, immediately thereafter, washed with pure water.

On the other hand, a test piece 1 cm in width and 4 cm in length was formed as a copper member 21 by pressing a copper plate having a thickness of 0.2 mm. The surface area of the copper member 21 was defined as 8 cm² as the sum of the upper surface area (1 cm (width)×4 cm=4 cm²) and the lower surface area (1 cm (width)×4 cm=4 cm²) while the side surface area was neglected. This copper member 21 was immersed in an aqueous solution of 1% by mass benzotriazole represented by the following formula (5) at 50° C. for 10 seconds, and then air-dried at room temperature. The benzotriazole used was BT-120 (manufactured by JOHOKU CHEMICAL CO., LTD.).

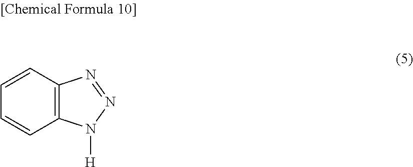

As shown in FIG. 5, the metal member 20 was immersed in 50 ml of an aqueous solution of 5% by mass NaCl put in a container. On the other hand, the copper member 21 was immersed in 2000 ml of an aqueous solution of 5% by mass NaCl put in a container which was different from the container in which the metal member was immersed. The aqueous NaCl solution in which the metal member 20 was immersed and the aqueous NaCl solution in which the copper member 21 was immersed were electrically connected by a salt bridge 24. The metal member 20 and the copper member 21 were electrically connected by a conductor wire 23 via an ammeter 22. This ammeter 22 was used to measure corrosion current flowing between the metal member 20 and the copper member 21.

In the above-described experimental device, the temperature of the aqueous solutions was kept at 50° C., and the current value 1 hour after the immersion of the metal member 20 and the copper member 21 in the aqueous NaCl solutions was recorded. A value obtained by dividing this current value by 8 cm² as the surface area of the copper member 21 is indicated in Table 1.

### Test Example 2

Corrosion current was measured as with Test Example 1, except that the copper member 21 was not immersed in the aqueous solution of 1% by mass benzotriazole.

TABLE 1

| | Current (μA/cm²) |
|---|---|
| Test Example 1 | 21.0 |
| Test Example 2 | 24.0 |

In the tests conducted this time, Test Example 1 is defined as a working example, and Test Example 2 is defined as a comparative example. The corrosion current in Test Example 2 was 24.0 μA/cm², whereas the corrosion current in Test Example 1 was reduced to 21.0 μA/cm². The corrosion current could be reduced by 12.5%.

(Test 2 for Evaluation of Corrosion Current)

Subsequently, the corrosion current when using a surface treating agent including a benzotriazole derivative was evaluated.

### Test Example 3

The copper member 21 was immersed in a benzotriazole derivative represented by the following formula (6) at 50° C. for 10 seconds, and then dried at 80° C. for 10 minutes. Drying was carried out by putting a new copper plate on a heated hot plate, putting on this copper plate the copper member 21 immersed in the benzotriazole derivative and allowing it to stand for 10 minutes. The benzotriazole derivative used was BT-LX (manufactured by JOHOKU CHEMICAL CO., LTD.).

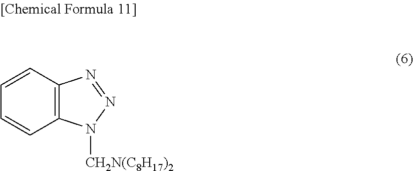

The corrosion current was measured as with Test Example 1 except the above point. The result is summarized in Table 2.

### Test Example 4

The corrosion current was measured as with Test Example 3 except that the drying temperature of the copper member 21 immersed in the benzotriazole derivative was defined as 100° C. The result is summarized in Table 2.

### Test Example 5

The corrosion current was measured as with Test Example 3 except that the drying temperature of the copper member 21 immersed in the benzotriazole derivative was defined as 150° C. The result is summarized in Table 2.

### Test Example 6

The corrosion current was measured as with Test Example 3 except that the copper member 21 immersed in the benzotriazole derivative was not dried with a hot plate. The result is summarized in Table 2.

TABLE 2

| | Drying Temperature (° C.) | Current (μA/cm²) |
|---|---|---|
| Test Example 3 | 80 | 1.5 |
| Test Example 4 | 100 | 2.7 |
| Test Example 5 | 150 | 1.8 |
| Test Example 6 | — | 6.0 |
| Test Example 2 | — | 24.0 |

In the tests conducted this time, Tests Examples 3 to 6 are defined as working examples, and Test Example 2 is defined as a comparative example. The corrosion current in Test Example 2 was 24.0 μA/cm², whereas the corrosion currents in Test Examples 3 to 6 were reduced to 1.5 μA/cm² to 6.0 μA/cm², and it has been found that the remarkable effect of reduction in corrosion current by 93.8% to 75.0% is obtained. Thus, it has been found that the surface treatment of the copper member 21 is carried out by using the benzotriazole derivative according to Formula (4), thereby making it possible to suppress the electric erosion of the metal member 20.

No strict comparison can be made because Test Examples 3 to 6 are different in drying temperature from Test Example 1 involving surface treatment with benzotriazole. However, the corrosion current in Test Example 1 is 21.0 μA/cm², whereas the corrosion currents in Test Examples 3 to 6 employing the benzotriazole derivative represented by Formula (4) were 1.5 μA/cm² to 6.0 μA/cm², which could be reduced by 92.8% to 71.4% as compared with the corrosion current in Test Example 1. This is considered to be because the deposition of water on the surface of the copper member 21 can be suppressed due to the hydrophobic group possessed by the benzotriazole derivative represented by Formula (4). Thus, it is considered that the arrival of the dissolved oxygen contained in water at the surface of the copper member 21 can be suppressed, thereby making it possible to further suppress flow of the corrosion current.

(Test 3 for Evaluation of Corrosion Current)

Then, the corrosion current when using a surface treating agent including a benzotriazole derivative which was different from the benzotriazole derivative used in Test Examples 3 to 6 was evaluated.

### Test Example 7

The copper member 21 was immersed in a surface treating agent including both or either one of a benzotriazole derivative represented by the following chemical formula (7) and a benzotriazole derivative represented by the following chemical formula (8) at 50° C. for 10 seconds, and thereafter dried at 80° C. for 10 minutes. Drying was carried out by putting a new copper plate on a heated hot plate, putting on this copper plate the copper member 21 immersed in the benzotriazole derivative and allowing it to stand for 10 minutes. The benzotriazole derivative used was TT-LX (manufactured by JOHOKU CHEMICAL CO., LTD.).

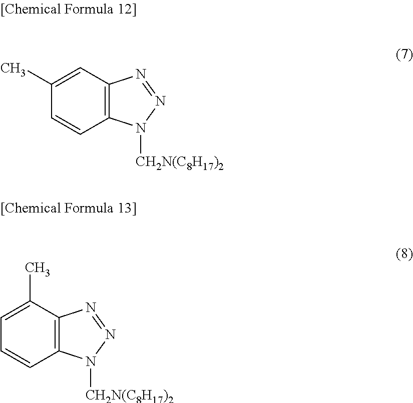

The corrosion current was measured as with Text Example 1 except the above point. The result is summarized in Table 3.

### Test Example 8

The corrosion current was measured as with Test Example 7 except that the drying temperature of the copper member 21 immersed in the benzotriazole derivative was defined as 100° C. The result is summarized in Table 3.

### Test Example 9

The corrosion current was measured as with Test Example 7 except that the drying temperature of the copper member 21 immersed in the benzotriazole derivative was defined as 150° C. The result is summarized in Table 3.

### Test Example 10

The corrosion current was measured as with Test Example 7 except that the copper member 21 immersed in the benzotriazole derivative was not dried with a hot plate. The result is summarized in Table 2.

TABLE 3

| | Drying Temperature (° C.) | Current (μA/cm²) |
|---|---|---|
| Test Example 7 | 80 | 0.8 |
| Test Example 8 | 100 | 0.6 |
| Test Example 9 | 150 | 2.0 |
| Test Example 10 | — | 3.0 |
| Test Example 2 | — | 24.0 |

In the tests conducted this time, Test Examples 7 to 10 are defined as working examples, and Test Example 2 is defined as a comparative example. The corrosion current in Test Example 2 was 24.0 μA/cm², whereas the corrosion currents in Test Examples 7 to 10 were reduced to 0.6 μA/cm² to 3.0 μA/cm², and it has been found that the remarkable effect of reduction in corrosion current by 96.7% to 87.5% is obtained. Thus, it has been found that the surface treatment of the copper member 21 is carried out by the benzotriazole derivatives represented by Formulae (5) and (6), thereby making it possible to suppress the electric erosion of the metal member 20.

No strict comparison can be made because Test Examples 7 to 10 are different in drying temperature from Test Example 1 involving surface treatment with a benzotriazole. However, the corrosion current in Test Example 1 is 21.0 μA/cm², whereas the corrosion currents in Test Examples 7 to 10 employing the benzotriazole derivatives represented by Formulae (5) and (6) were 0.6 μA/cm² to 3.0 μA/cm², which could be reduced by 97.1% to 85.7% as compared with the corrosion current in Test Example 1. This is considered to be because a methyl group was substituted on the aromatic ring in the benzotriazole derivatives represented by Formulae (5) and (6), so that hydrophobicity became further high.

### First Embodiment (2)

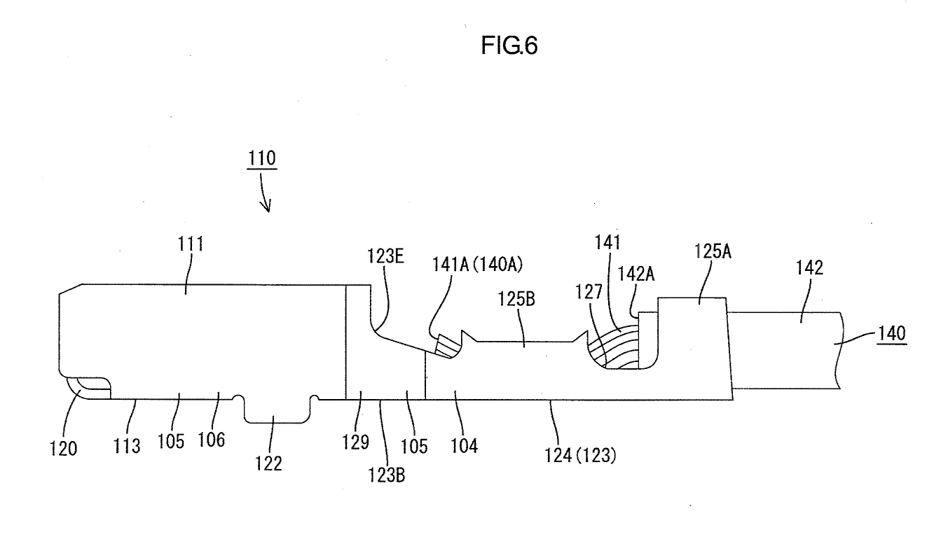

Next, a first embodiment (2) of the present invention will be explained with reference to FIGS. 6 to 9. In the following explanation, the left side in FIGS. 6, 7 and 9 is defined as front side, and the right side therein is defined as back side. Also, the upper side in FIG. 1 is defined as upper side, and the lower side therein is defined as lower side. In the meantime, the explanation of the parts overlapping with those in the first embodiment (1) will be omitted.

(Terminal 110)

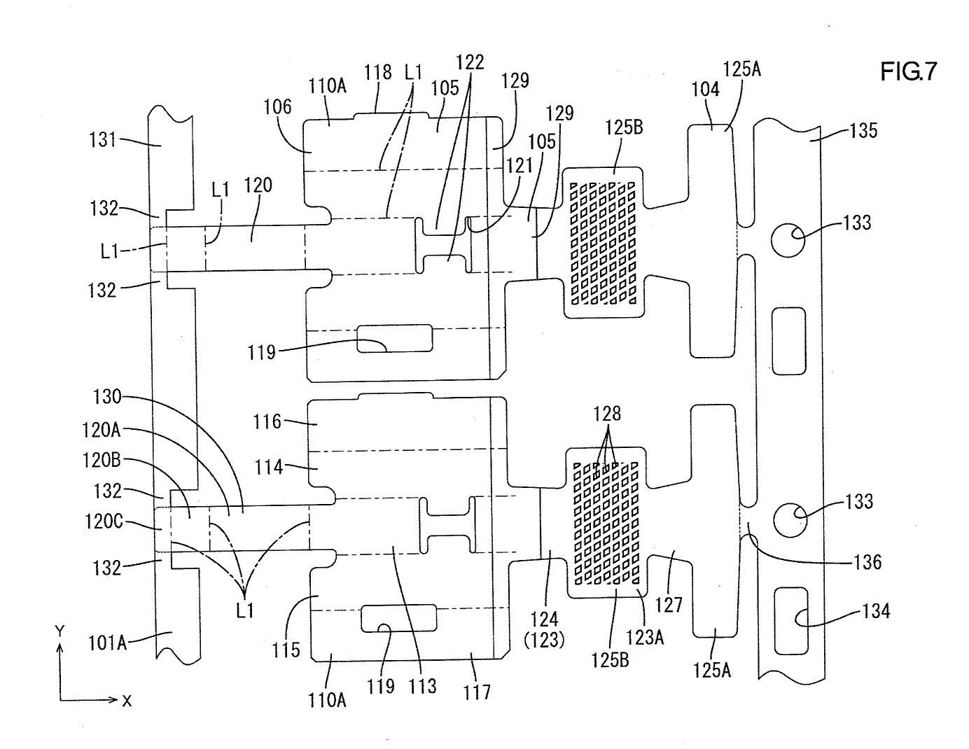

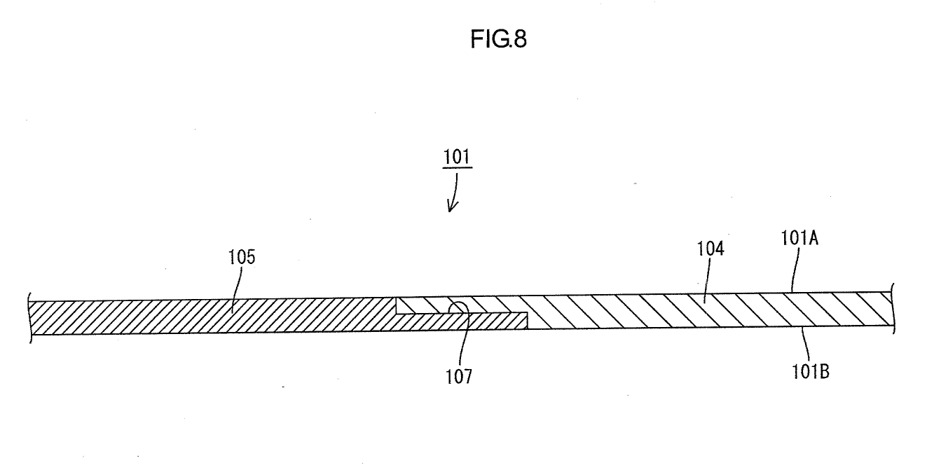

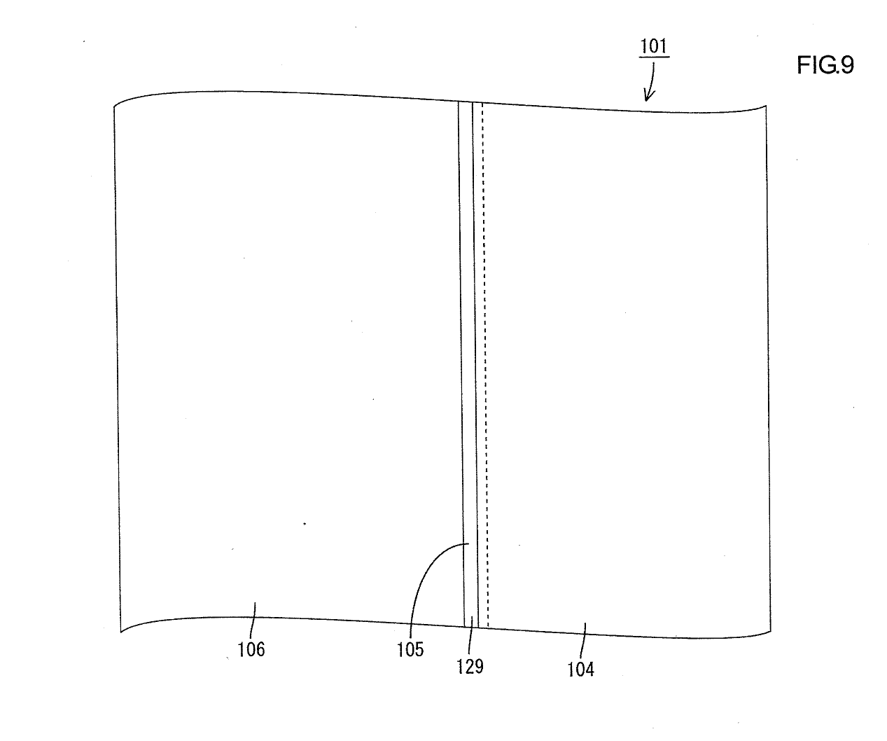

A terminal 110 according to the present embodiment is a female terminal 110 as shown in FIG. 6. The terminal 110 is composed of a metal plate material 101 (the details thereof will be described below) in which a metal region 104 including a metal having an ionization tendency greater than that of copper and a copper region 105 including copper or a copper alloy are bonded in juxtaposition. In the present embodiment, the metal region 104 includes aluminum or an aluminum alloy. The terminal 110 of the present embodiment is formed in a shape as shown in FIG. 6 by applying, for example, bending process to a terminal piece 110A having a developed shape as shown in FIG. 7. An alumite layer (not shown) is formed on the upper and lower surfaces of the metal region 104 by alumite treatment.

The terminal 110 has an approximately box-shaped main body part 111 having openings in the front and back parts. The main body part 111 is configured such that a tab (not shown) of a male terminal would be inserted therein from the front side. A wire connection part 123 in which a wire 140 is connected is provided on the back side of the main body part 111.

(Main Body Part 111)

The main body part 111 is formed in a rectangular cylindrical shape by bending the terminal piece 110A having the developed shape as shown in FIG. 7 along a bending line L1. The main body part 111 is composed of a bottom wall 113 which extends backward and forward, a pair of side walls 114, 115 which are erected from both side edges of the bottom wall 113, a ceiling wall 116 which is continuous from the side wall 114 and opposite to the bottom wall 113, and an outer wall 117 which is continuous from the side wall 115 and superposed onto the outside of the ceiling wall 116.

The ceiling wall 116 includes, at its side edge, a support piece 118 which protrudes toward the side of the side wall 115. This support piece 118 is inserted into an insertion groove 119 that is formed by cutting the outer wall 117, and comes in contact with the side edge of the insertion groove 119 (upper end surface of the side wall 115), so that the ceiling wall 116 is supported so as to be in a posture which is nearly parallel with the bottom wall 113.

The bottom wall 113 includes, at its front end, an elastic contact piece 120 which projects so as to be in elastic contact with the tab. The details of the structure of the elastic contact piece 120 are not shown, but the elastic contact piece 120 is formed by folding a tongue piece 130, which is straightly extended frontward from the bottom wall 113 in the developed state shown in FIG. 7, backward at the front end position of the main body part 111, and then folding it frontward at an approximately center position in the length direction in the main body part 111.

The portion of the elastic contact piece 120 between the front and back folded parts is defined as a tab contact part 120A which is opposite to the ceiling wall 116 and can be in direct contact with the tab. On the other hand, the portion which protrudes frontward from the back folded part of the elastic contact piece 120 is defined as a support part 120B which is configured to contact the bottom wall 113. A tip end part 120C of the support part 120B is formed so as to be bent upward. The elastic contact piece 120 can hold the tab which is inserted into the main body part 111, between the ceiling wall 116 and the tab contact part 120A, in a state where the tab is nipped under pressure, and is pushed by the tab so as to be elastically deformed. At this time, the support part 120B contacts the bottom wall 113, and the tip end part 120C of the support part 120B contacts the rear side of the tab contact part 120A, so that excessive deflection of the elastic contact piece 120 can be regulated. Also, the elastic contact piece 120 is formed so as to be narrower than the bottom wall 113. The bottom wall 113 has a locking hole 121 opened and formed therein such that, when the terminal 110 is housed within a cavity of a housing (not shown), a lance (not shown) which is provided within the cavity enters the hole 121 and can lock the terminal 110. A pair of stabilizers 122 which function, for example, to guide the operation of insertion into the cavity are protruded from both side edges (lower ends of both side walls 114, 115) of the locking hole 121.

(Wire Connection Part 123)

A wire connection part 123 of the terminal 110 is provided so as to be extended backward from the back end of the bottom wall 113 of the main body part 111 as shown in FIG. 6. The upper surface of the wire connection part 123 is defined as a wire placing surface 123A on which a wire 140 is placed. This wire 140 is crimped by two sets of barrel parts 125A, 125B.

The wire 140 is obtained by covering a core wire 141 formed by twisting metal fine wires (for example, metal fine wires made of aluminum or an aluminum alloy) with an insulating cover 142 made of an insulating material. Examples of the aluminum alloy used as the material for the wire 140 in the present embodiment include aluminum alloys of JIS A5052 and aluminum alloys of JIS A5083.

The terminal 140A of the wire 140 is in a state where the insulating cover 142 is peeled and therefore the core wire 141 is exposed, as shown in FIG. 1. The wire 140 is connected to the terminal 110 while the front end 141 A (terminal 141A) of the exposed core wire 141 is directed to the side of the main body part 111. The portion of the wire connection part 123, to which the core wire 141 exposed in the terminal 140A of the wire 140 is connected, is a core wire connection part 124.

The terminal 110 has a wire barrel part 125B connected to the core wire 141 of the wire 140 and an insulation barrel part 125A connected to the insulating cover 142 of the wire 140, the barrel parts 125B and 125A being formed with an interval so as to be continuous from the bottom wall 113 of the main body part 111 and so as to be projected in the width direction of the bottom wall 113 (see FIG. 7). Of the two of barrel parts 125A, 125B, the barrel part 125B on the front side (side of the main body part 111) is the wire barrel part 125B that is configured to be crimped on the exposed core wire 141 to electrically connect the exposed core wire 141 to the terminal 110, and the barrel part 125A on the back side (back end side) is an insulation barrel part 125A that is configured to be crimped on the portion of the wire 140 covered with the insulating cover 142 of the wire 140 to connect the wire 140 to the terminal 110.

The wire placing surface 123A of the wire barrel part 125B is provided with a plurality of concave parts 128 for breaking the metal oxide film formed around the core wire 141 when the wire 140 is crimped (see FIG. 7).

The hole edges of the concave parts 128 have a parallelogram shape when viewed from a direction penetrating through the paper plane in FIG. 7 in a state before the wire 140 is crimped. The plurality of concave parts 128 are arranged at intervals in a direction in which the core wire 141 extends in a state where the wire barrel part 125B is crimped to the core wire 141, and also arranged at intervals in a direction crossing the direction in which the core wire 141 extends.

A region 126 between the wire barrel part 125B and the back end of the main body part 111 is an end part arrangement region 126 where the terminal 140A of the wire 140 is arranged. This end part arrangement region 126 is partly in an upward open state in a state where the wire 140 is connected thereto, and the core wire 141 is arranged in an exposed state (state visible from the outside) therein (see FIG. 6).

A region 127 between the wire barrel part 125B and the insulation barrel part 125A is a core wire arrangement region 127 where the terminal 142A of the insulating cover 142 and the core wire 141 exposed from the terminal 142A of the insulating cover 142 are arranged, and is partly in an upward open state in a state where the wire 140 is connected thereto, as with the end part arrangement region 126, and the core wire 141 is arranged in an exposed state (state visible from the outside) therein (see FIG. 6).

(Plated Region 106)

A plated region 106 plated with a plating metal having an ionization tendency that is closer to that of the copper member than to that of aluminum (alloy) is formed in a position closer to the back end part from the front end part of the main body part 111. As the plating metal, zinc, nickel, tin and the like can be used. In the present embodiment, tin is used as the plating metal.

(Surface Treatment Layer 129)

In the terminal 110 of the present embodiment, a surface treatment layer 129 including a surface treating agent is formed at the front end 123E of the wire connection part 123 and in a portion of the main body part 111 where the plated layer is not formed. The surface treatment layer 129 is formed both on the wire placing surface 123A (surface arranged on the upper side in FIG. 6) where the wire 140 is placed and on a surface 123B opposite thereto (see FIGS. 6 and 7). The portion covered with the surface treatment layer 129 is shown in a hatched manner in the drawing. The surface treatment layer 129 is formed more closely to the main body part 111 than to the front end of the wire 140 (front end 141A of the core wire 141) connected to the wire connection part 123, and therefore does not adversely affect electric connection between the terminal 110 and the wire 140.

(Metal Plate Material 101)

Next, the metal plate material 101 which constitutes the terminal 110 of the present embodiment will be explained. The metal plate material 101 used in the present embodiment is a clad material in which a metal region 104 made of aluminum or an aluminum alloy (referred to also as “aluminum (alloy)”) and a copper region 105 made of copper or a copper alloy (referred to also as “copper (alloy)”) are bonded in juxtaposition, as shown in FIG. 8.

The metal plate material 101 is formed in a flat plate-like shape with a substantially constant thickness including a bonding part 107 between aluminum (alloy) and copper (alloy) as shown in FIGS. 8 and 9. In the bonding part 107 between aluminum (alloy) and copper (alloy), the layer made of aluminum (alloy) and the layer made of copper (alloy) each have a thickness which is about ½ of the thickness of the other parts, and are superposed on each other. Both surfaces 101A, 101B of the metal plate material 101 have the surface treatment layer 129 formed so as to cover a region of the copper region 105 where the plated layer is not formed.

(Production Process)

Next, an example of production process of the terminal 110 of the present embodiment will be explained. Firstly, a metal plate material 101 which serves as a material for the terminal 110 is prepared (a plate material preparation step). Specifically, aluminum (alloy) and copper (alloy) are integrated by cold welding, thereby preparing a clad material shaped like a flat plate in which a metal region 104 made of aluminum (alloy) and a copper region 105 made of copper (alloy) are bonded in juxtaposition.

(Plating Step)

Next, the plating step of plating the surfaces 101A, 101B of the metal plate material 101 obtained by carrying out the plate material preparation step with a plating metal having an ionization tendency closer to that of the copper member than to that of aluminum (alloy), is carried out. In the present embodiment, tin plating is applied. The metal region 104 of the metal plate material 101 and the region of the copper region 105 where the plated region 106 is not formed are masked by a known method. Then, tin plating is applied to the copper region 105 by a known method. Thereafter, the masking is removed.

(Alumite Treatment Step)

Next, the alumite treatment step of forming an alumite layer on the surfaces 101A, 101B in the metal region 104 of the metal plate material 101 is carried out. A region of the metal plate material 101 except the metal region 104 is masked by a known method. Then, an alumite layer is formed on the metal region 104 by a known method. Thereafter, the masking is removed.

(Surface Treatment Step)

Next, the surface treatment step of forming a surface treatment layer 129 on the surfaces 101A, 101B of the metal plate material 101 is carried out. The region of the metal plate material 101 where the plated layer is formed and the region where the alumite layer is formed are masked by a known technique. Then, the surface treating agent is applied to the surfaces 101A, 101B of the metal plate material 101. A method for applying the surface treating agent may be immersion of the metal plate material 101 in the surface treating agent, application of the surface treating agent to the metal plate material 101 with a brush or spraying of the surface treating agent or a solution obtained by dissolving the surface treating agent in a solvent onto the metal plate material 101, and any technique can appropriately be selected according to need. Thereafter, the masking is removed. Thus, the metal plate material 101 is formed (see FIG. 9).

The order of plating step, alumite treatment step and surface treatment step is not limited to the above-described order, and the steps can be carried out in any order.

(Punching Step)

Next, the metal plate material 101 is punched (punching step), thereby obtaining a chain terminal as shown in FIG. 7. In the meantime, in the present embodiment, the punching step is carried out in order that almost the entire area of the main body part 111 can be formed in the copper region 105 and that almost the entire area of the wire connection part 123 can be formed in the metal region 104 of the metal plate material 101.

(Pressing Step)

Then, the wire placing surface 123A of the wire barrel part 125B is pressed using a die having a plurality of convex parts (not shown) formed so as to be protruded therefrom (pressing step), thereby forming a plurality of concave parts 128. Thus, a chain terminal (not shown) is obtained.

In the chain terminal (metal plate material obtained after execution of the punching step), a plurality of terminal pieces 110A continue to carriers 131, 135. The chain terminal is configured such that multiple terminal pieces 110A continue to the pair of belt-like carriers 131, 135 extending along the lateral direction shown in the drawing in a state where they are aligned at nearly equal intervals along the lateral direction shown in the drawing, namely, in the longitudinal direction (extending direction) of the carriers 131, 135. The front and back end parts of the respective terminal pieces 110A continue to edges of the respective carriers 131, 135 in the width direction. The length direction of the terminal pieces 110A corresponds to the lengthwise direction shown in the drawing, namely, the width direction in the chain terminal.

The front end part of the terminal piece 110A continues to the carrier 131 on the left side in FIG. 7. The tip end part 120C of the elastic contact piece 120 formed in the front end part of the terminal piece 110A is formed at a place indented into the width region of the carrier 131. A connection 132 which continues to the front end part of this terminal piece 110A and the carrier 131 are aligned in juxtaposition in the lateral direction shown in the drawing.

The back end part of the terminal piece 110A continues to a connection 136 protruded from the side edge of the carrier 135 on the right side in FIG. 7. The connection 136 continues to substantially the center of the width direction at the back end of the insulation barrel part 125A in the terminal piece 110A. These terminal pieces 110A, connections 136 and carrier 135 are arranged in juxtaposition in the lengthwise direction shown in the drawing, namely, in the width direction when viewed from the entire chain terminal. This carrier 135 has feed holes 133, 134 opened and formed so as to be engageable with feeding claws (not shown) which are provided in a processing machine in order to feed out the chain terminal. As these feed holes 133, 134, due to the difference in shape of the feeding claws depending on the type of the processing machine (for example, pressing machine and welding machine), two types of feed holes, i.e., circular feed holes 133 and rectangular feeding hole 134 are provided in accordance with the shape of the feeding claw shape.

Next, upon engagement of the feeding claws in the feed holes 133, 134 formed in the carriers 131, 135, the terminal pieces 110A are sequentially fed to the processing machine, and, for example, bending is applied to the terminal pieces 110A during the process. In the present embodiment, the metal plate material 101 has a substantially constant thickness, so that bending can be easily applied also to the bonding part 107 where the first metal material and the second metal material are bonded to each other.

(Crimping Step)

Next, the crimping step of crimping the insulation barrel part 125A and wire barrel part 125B provided in the electric connection part 123 of the individual terminal pieces 110A to the wire 140 for connection between the terminal 110 and the wire 140, is carried out. Specifically, the wire 140 is placed such that the front end 141A (terminal 141A) of its core wire 141 is arranged in the end part arrangement region 126 of the electric connection part 123 and that the terminal 142A of the insulating cover 142 is arranged in the core wire arrangement region 127, and then the wire barrel part 125B and insulation barrel part 125A are each crimped to the wire 140.

(Functions and Effects of the Present Embodiment)

Subsequently, the functions and effects of the present embodiment will be explained. The terminal 110 according to the present embodiment is formed of a metal plate material 101 in which the copper member and the metal member are cold-welded, and has the copper region 105 including the copper member and a metal region 104 including the metal member, which regions are aligned in juxtaposition, and the surface treatment layer 129 is formed in the copper region 105. Thus, corrosion of the metal member by electric erosion can be suppressed for the terminal 110 in which the copper member and the metal member are cold-welded to be integrally formed.

Also, according to the present embodiment, the copper region 105 has a plated region 106 which is plated with a plating metal having an ionization tendency that is closer to that of the copper member than to that of the metal member, and the surface treatment layer 129 is formed at least in a region of the copper region 105 where the plated region 106 is not formed. Thus, the differences in ionization tendency between the metal region 104 and the plated region 106 and between the copper region 105 and the plated region 106 are smaller than that between the metal region 104 and the copper region 105. Thus, electric erosion is less likely to occur, thereby suppressing the electric erosion speed.

Also, according to the present embodiment, the metal member includes aluminum or an aluminum alloy, and an alumite layer is formed on the surface of the metal region 104. The surface of the metal region 104 is covered with the alumite layer, so that elution of aluminum in water is suppressed. Thus, corrosion of the metal member by electric erosion can further be suppressed.

The above-described alumite layer is relatively hard, and thus, when the wire barrel part 125B is crimped to the core wire 141, the layer is brought in slide-contact with the core wire 141, thus finely broken and then peeled from the wire barrel part 125B. Then, a newly-generated surface of a metal which constitutes the wire barrel part 125B is exposed. Also, the finely-broken alumite layer is brought in slide-contact with the surface of the core wire 141, thereby making it possible to effectively peel off the oxide film formed on the surface of the core wire 141. Then, a newly-generated surface of a metal which constitutes the core wire 141 is exposed. Thus, the newly-generated surface of a metal exposed in the wire barrel part 125B and the newly-generated surface of a metal exposed in the core wire 141 are brought in contact with each other, so that the wire barrel part 125B and the core wire 141 are reliably electrically connected. As a result of this, the reliability of the electric connection between the wire barrel part 125B and the core wire 141 can be improved.

### First Embodiment (3)

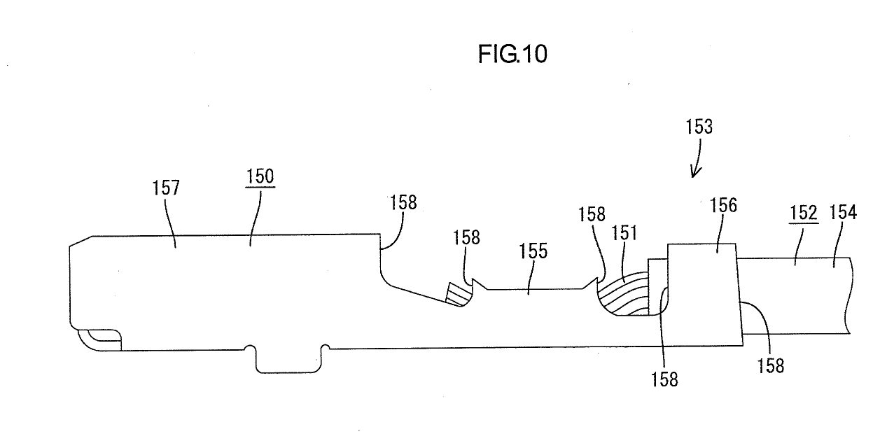

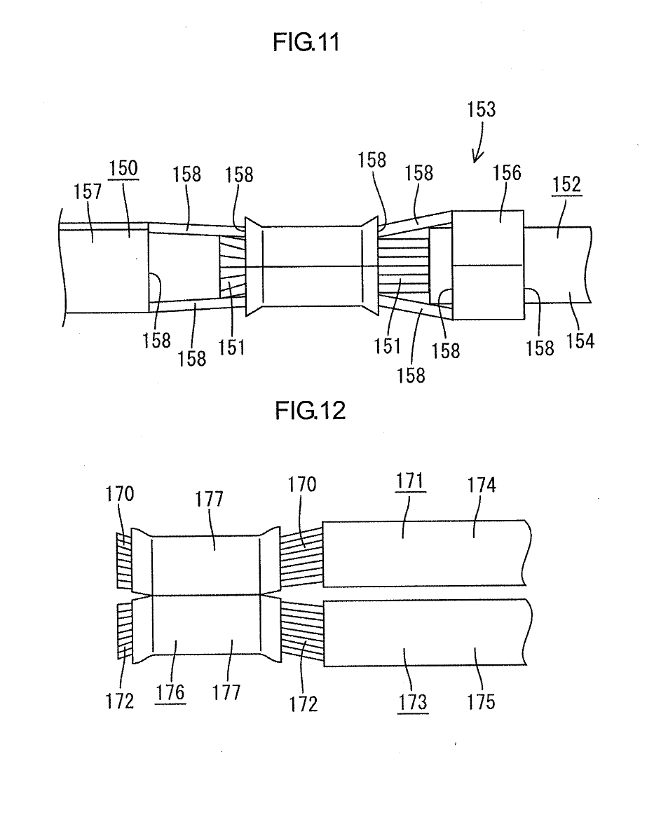

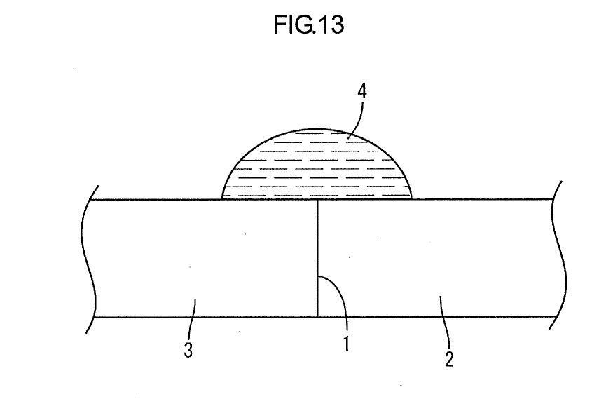

Next, a first embodiment (3) of the present invention will be explained with reference to FIGS. 10 and 11. The present embodiment is a wire with a terminal 153, which includes: a terminal 150 including copper or a copper alloy (one example of the copper member); and a wire 152 which is provided with a core wire 151 including a metal having an ionization tendency greater than that of copper (one example of the metal member). In the meantime, the explanation of the parts overlapping with those in the first embodiment (1) will be omitted.

(Wire 152)

The wire 152 is configured such that the outer periphery of the core wire 151 is enclosed with an insulating cover 154 made of a synthetic resin. Examples of the metal which constitutes the core wire 151 can include metals having an ionization tendency greater than that of copper, such as aluminum, manganese, zinc, chromium, iron, cadmium, cobalt, nickel, tin and lead or alloys thereof. In the present embodiment, the core wire 151 includes aluminum or an aluminum alloy. The core wire 151 according to the present embodiment is a stranded wire obtained by twisting a plurality of metal fine wires together. The core wire 151 may be a so-called single core wire made of a metal bar material. The wire with a terminal 153 can be reduced in weight as a whole because aluminum or an aluminum alloy has a relatively small specific weight.

(Terminal 150)

As shown in FIG. 10, the terminal 150 includes: a wire barrel part 155 connected to the core wire 151 that is exposed from the terminal of the wire 152; an insulation barrel part 156 which is formed on the back side of the wire barrel part 155 to hold the insulating cover 154; and a main body part 157 which is formed on the front side of the wire barrel part 155 and into which a tab (not shown) of a male terminal is to be inserted.

The terminal 150 is formed by pressing a metal plate material made of copper or a copper alloy into a predetermined shape. The surface of the terminal 150 is plated with a plating metal having an ionization tendency that is closer to that of the copper than to that of aluminum. Examples of usable plating metals include zinc, nickel and tin. In the present embodiment, tin is used as the plating metal since the contact resistance between the core wire and the wire barrel part can be reduced.

As shown in FIG. 11, copper or a copper alloy is exposed on end surfaces 158 of the terminal 150. Each end surface 158 has a surface treatment layer (not shown) formed by a surface treating agent. In the present embodiment, the surface treatment layer is formed at least on the end surface 158 of the wire barrel part 155. Also, the core wire 151 is exposed from the wire barrel part 155 on the front and back sides of the wire barrel part 155.

The above-described surface treatment layer can be formed, for example, by crimping the terminal 150 to the wire 152 and, thereafter, immersing at least the terminal 150 and the core wire 151 exposed from the wire 152 in the surface treating agent. Also, for example, the surface treatment layer can be formed on the end surface 158 of the terminal 150 by mixing the surface treating agent in a press oil when pressing the metal plate material made of copper or a copper alloy.

(Operation/Effect of the Present Embodiment)

The terminal 150 is formed by pressing a metal plate material into a predetermined shape. Therefore, the copper or copper alloy which constitutes the metal plate material is exposed on the end surface 158 of the wire barrel part 155 after pressing, regardless of whether the metal plate material is plated or not. In the state where copper or a copper alloy is exposed on the end surface 158 of the wire barrel part 155, water is deposited here, and thus electric erosion may be promoted due to the difference in ionization tendency from aluminum or an aluminum alloy contained in the core wire 151, leading to the elution of aluminum from the core wire 151.

In light of this point, the surface treatment layer is formed at least on the end surface 158 of the wire barrel part 155 in the present embodiment, and, hence, no copper or copper alloy is exposed on the end surface 158 of the wire barrel part 155. Thus, electric erosion of the core wire 151 can be suppressed.

Also, the surface treatment layer is formed on the end surface 158 of the terminal 150, so that electric erosion of the core wire 151 can further be suppressed.

### First Embodiment (4)

Next, a first embodiment (4) of the present invention will be explained with reference to FIG. 12. The present embodiment is configured such that a copper wire 171 (corresponding to the first wire) which is provided with a copper core wire 170 (corresponding to the first core wire) including copper or a copper alloy and an aluminum wire 173 (corresponding to the second wire) which is provided with an aluminum core wire 172 (corresponding to the second core wire) including aluminum or an aluminum alloy having an ionization tendency greater than that of copper are connected to each other. The outer periphery of the copper core wire 170 is covered with the insulating cover 174 made of a synthetic resin, and the outer periphery of the aluminum core wire is covered with an insulating cover 175 made of a synthetic resin. In the meantime, the explanation of the parts overlapping with those in the first embodiment (1) will be omitted.

In the present embodiment, the copper core wire 170 and the aluminum core wire 172 are electrically connected by a splice terminal 176. The splice terminal 176 has a wire barrel part 177 to be crimped so as to be wound both around the copper core wire 170 and around the aluminum core wire 172.

The metal for the splice terminal 176 can be appropriately selected from any materials, according to need, including copper, copper alloys, aluminum, aluminum alloys, iron and iron alloys. The surface of the splice terminal 176 may be plated with a plating metal having an ionization tendency that is closer to that of copper than to that of aluminum. Examples of usable plating metals include zinc, nickel and tin.

The copper core wire 170, aluminum core wire 172 and splice terminal 176 are immersed in the surface treating agent, whereby a surface treatment layer (not shown) is formed on the surfaces of the copper core wire 170, aluminum core wire 172 and splice terminal 176. Thus, the elution of the aluminum core wire 172 by electric erosion can be suppressed.

In the meantime, the copper core wire 170 and aluminum core wire 172 are not limited to the case where they are connected by the splice terminal 176. For example, the copper core wire 170 and aluminum core wire 172 can be connected by any technique such as resistance welding, ultrasonic welding, cold welding or crimping by heating, according to need.

### Second embodiment (1)

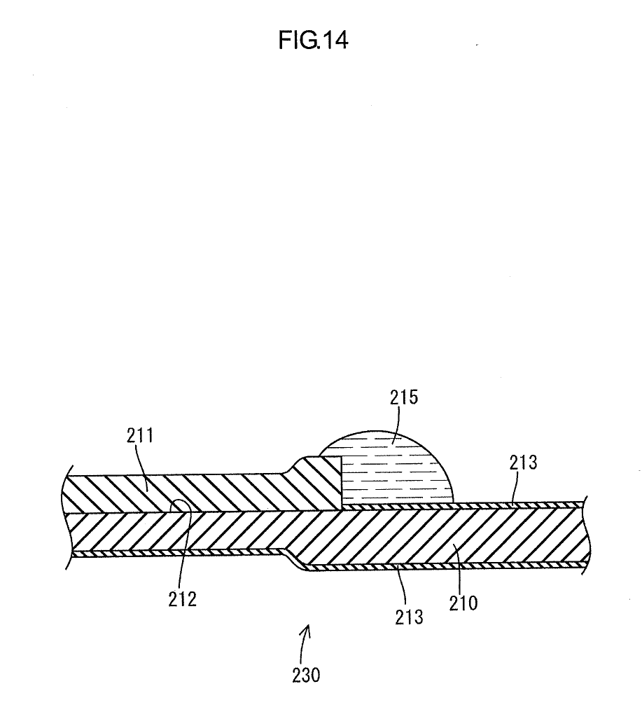

A second embodiment (1) according to the present invention will be explained with reference to FIGS. 14 to 17. The present embodiment is an electric connection structure 230 including a copper member 210 and a metal member 211 including a metal having an ionization tendency greater than that of copper.

(Metal Member 211)

As shown in FIG. 14, the metal member 211 includes a metal having an ionization tendency greater than that of copper. Examples of the metal contained in the metal member 211 can include magnesium, aluminum, manganese, zinc, chromium, iron, cadmium, cobalt, nickel, tin and lead or alloys thereof. In the present embodiment, the metal member 211 is formed by pressing a plate material including aluminum or an aluminum alloy into a predetermined shape.

(Copper Member 210)

The copper member 210 includes copper or a copper alloy. In the present embodiment, the copper member 210 is formed by pressing a plate material including copper or a copper alloy into a predetermined shape.

(Connection Structure)

As a method for connecting the metal member 211 and the copper member 210, any connection method such as resistance welding, ultrasonic welding, brazing connection (including brazing and soldering), cold welding, welding or bolting can be appropriately selected according to need. In the present embodiment, the metal member 211 and the copper member 210 are welded by being nipped between a pair of jigs 214. In a connection part 212 where the metal member 11 and the copper member 210 are connected by welding, the metal member 211 and the copper member 210 are electrically connected to each other.

(Water Resistant Layer 213)

A water resistant layer 213 is formed in a portion of the copper member 210 different from the connection part 212. The water resistant layer 213 is formed in a portion of the surface of the copper member 210 different from the connection part 212 which is in contact with the metal member 211. The surface of the copper member 210 refers to all the surfaces of the copper member 210 that are exposed to the outside, for example, the upper, lower and side surfaces thereof. The water resistant layer 213 according to the present embodiment is formed at least on the copper member 210.

The water resistant layer 213 includes a basic compound having an affinity group with affinity for the copper member 210 and having a basic group; and an acidic compound having an acidic group to be reacted with the basic group and having a hydrophobic group.

The affinity group contained in the basic compound has affinity for the surface of the copper member 210. The phrase “has affinity” encompasses the case where electrons contained in the affinity group are bound to the surface of the copper member 210, for example, through a coordinate bond or an ion bond as well as the case where the affinity group is more strongly adsorbed onto the surface of the copper member 210 than mere physical adsorption, through some interaction (for example, Coulomb's force) between the electrons contained in the affinity group and the surface of the copper member 210.

The affinity group may have affinity for the copper atom exposed on the surface of the copper member 210, may have affinity for the copper oxide formed on the surface of the copper member 210, or may have affinity for a metal or metal compound other than copper contained in the copper member 210.

As described above, the affinity group is bound or adsorbed onto the surface of the copper member 210, thereby making it possible to suppress volatilization of the basic or acidic compound by heating or elution of the basic or acidic compound by means of a solvent. Thus, separation of the water resistant layer 213 from the surface of the copper member 210 is suppressed. As a result of this, the water resistant layer 213 is held on the surface of the copper member 210 stably over a long period.

The basic group contained in the basic compound reacts with the acidic group contained in the acidic compound to form a chemical bond. Thus, the basic and acidic compounds firmly bind together.

The water resistant layer has hydrophobicity due to the hydrophobic group contained in the acidic compound. The hydrophobic group has only to be hydrophobic at least in a part of its molecular structure. In other words, the acidic compound may have a hydrophilic group having hydrophilicity in a part of its molecular structure. Due to the hydrophobicity of this hydrophobic group, the invasion of water into the surface of the copper member 210 can be suppressed.

The affinity group can be introduced into the basic compound, for example, by using the following compounds. Examples of such compounds can include aminocarboxylic acid, polyamines, amino alcohols, heterocyclic bases, oximes, Schiff bases and tetrapyrroles. These compounds have a plurality of unshared electron pairs that can form a coordinate bond. These may be used singly, or two or more thereof may be used in combination.

More specifically, examples of various compounds can include aminocarboxylic acid such as ethylenediamine diacetic acid, ethylenediamine dipropionic acid, ethylenediamine tetraacetic acid, N-hydroxymethylethylenediamine triacetic acid, N-hydroxyethylethylenediamine triacetic acid, diaminocyclohexyl tetraacetic acid, diethylenetriamine pentaacetic acid, glycoletherdiamine tetraacetic acid, N,N-bis(2-hydroxybenzyl)ethylenediamine diacetic acid, hexamethylenediamine N,N,N,N-tetraacetic acid, hydroxyethylimino diacetic acid, imino diacetic acid, diaminopropane tetraacetic acid, nitrilo triacetic acid, nitrilo tripropionic acid, triethylenetetramine hexaacetic acid, and poly(p-vinylbenzylimino diacetic acid).

Examples of the polyamines can include ethylenediamine, triethylenetetramine, triaminotriethylamine, and polyethyleneimine. Examples of the amino alcohols can include triethanolamine, N-hydroxyethylethylenediamine, and polymetharyloylacetone.

Examples of the heterocyclic bases can include dipyridyl, o-phenanthroline, oxine, 8-hydroxyquinoline, benzotriazole, benzoimidazole and benzothiazole. Examples of the oximes can include dimethylglyoxime and salicylaldoxime. Examples of the Schiff bases can include dimethylglyoxime, salicylaldoxime, disalicylaldehyde and 1,2-propylenediimine.

Examples of the tetrapyrroles can include phthalocyanine and tetraphenylporphyrin.

A hydroxyl group, an amino group or the like may also be appropriately introduced to the above-described compound. Some of the above-described compounds can be present in the form of salt. In this case, they may be used in the form of salt. In addition, a hydrate or solvate of the above-described compound or the salt thereof may be used. In addition, the above-described compound, which includes an optical active material, may include any stereoisomer, a mixture of stereoisomers, or a racemic form.

The basic compound may be configured to include either one or both of a benzotriazole and a benzotriazole derivative. The benzotriazole derivative is represented by the following general formula (3):

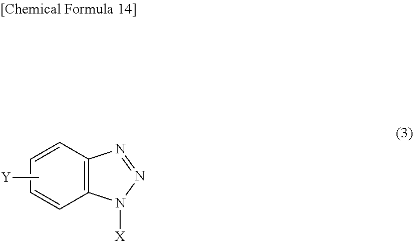

wherein X represents a hydrogen atom or an organic group; and Y represents a hydrogen atom or a lower alkyl group.

In the benzotriazole derivative represented by the general formula (3), the affinity group is a nitrogen-containing heterocyclic group.

The above-described organic group represented by X is represented by the following general formula (4):

[Chemical Formula 15]

—R—NH₂ (4)

wherein R represents an alkyl group having 1 to 3 carbon atoms.

As the basic group of the basic compound, an amino group or a nitrogen-containing heterocyclic group can be used. Examples of usable basic compounds including a nitrogen-containing heterocyclic group include pyrrol, pyrrolidine, imidazole, thiazole, pyridine, piperidine, pyrimidine, indole, quinoline, isoquino line, purine, imidazole, benzoimidazole, benzotriazole and benzothiazole or derivatives thereof.

Examples of the hydrophobic group of the acidic compound include linear or branched alkyl groups, vinyl groups, allyl groups, cycloalkyl groups and aryl groups. These may be used singly or as a combination of two or more thereof. At this time, if a fluorine atom is introduced, for example, into the linear or branched alkyl group, vinyl group, allyl group, cycloalkyl group, aryl group or the like, higher hydrophobicity is obtained. The hydrophobic group may include, for example, an amide bond, an ether bond or an ester bond. The hydrophobic group may include a double bond or a triple bond in the molecular chain of the hydrophobic group.

Examples of the alkyl group can include a linear alkyl group, a branched alkyl group or a cycloalkyl group.

Examples of the linear alkyl group include a methyl group, an ethyl group, a propyl group, a butyl group, a propyl group, a pentyl group, a hexyl group, a heptyl group, an octyl group, a nonyl group, a decyl group, an undecyl group, a dodecyl group, a tridecyl group, a tetradecyl group and a pentadecyl group. The number of carbon atoms of the linear alkyl group preferably ranges from 1 to 100, more preferably ranges from 3 to 30, further preferably ranges from 5 to 25, especially preferably ranges from 10 to 20.

Examples of the branched alkyl group include an isopropyl group, a 1-methylpropyl group, a 2-methylpropyl group, a tert-butyl group, a 1-methylbutyl group, a 2-methylbutyl group, 3-methylbutyl group, a 1,1-dimethylpropyl group, a 1,2-dimethylpropyl group, a 2,2-dimethylpropyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 5-methylhexyl group, a 6-methylheptyl group, a 2-methylhexyl group, a 2-ethylhexyl group, a 2-methylheptyl group and a 2-ethylheptyl group. The number of carbon atoms of the branched alkyl group preferably ranges from 1 to 100, more preferably ranges from 3 to 30, further preferably ranges from 5 to 25, especially preferably ranges from 10 to 20.

Examples of the cycloalkyl group include a cyclopropyl group, a cyclobutyl group, a cyclopentyl group, a methylcyclopentyl group, a dimethylcyclopentyl group, a cyclopentylmethyl group, a cylopentylethyl group, a cylohexyl group, a methylcyclohexyl group, a dimethylcyclohexyl group, a cylohexylmethyl group and a cyclohexylethyl group. The number of carbon atoms of the cycloalkyl group preferably ranges from 3 to 100, more preferably ranges from 3 to 30, further preferably ranges from 5 to 25, especially preferably ranges from 10 to 20.

Examples of the aryl group include a phenyl group, a 1-naphtyl group, a 2-naphtyl group, a 2-phenylphenyl group, a 3-phenylphenyl group, a 4-phenylphenyl group, a 9-anthryl group, a methylphenyl group, a dimethylphenyl group, a trimethylphenyl group, an ethylphenyl group, a methylethylphenyl group, a diethylphenyl group, a propylphenyl group and a butylphenyl group. The number of carbon atoms of the aryl group preferably ranges from 6 to 100, more preferably ranges from 7 to 30, further preferably ranges from 8 to 20, especially preferably ranges from 10 to 20.

Also, the above-described Y is preferably a hydrogen atom or a lower alkyl group, further preferably a methyl group.

Examples of usable acidic groups contained in the acidic compound include one group or two or more groups selected from the group consisting of a carboxyl group, a phosphate group, a phosphonic acid group and a sulfonyl group.

One and both of the basic and acidic compounds may also be configured to be dissolved in a known solvent. As the solvent, for example, water, an organic solvent, wax, oil or the like can be used. Examples of the organic solvent include aliphatic solvents such as n-hexane, isohexane and n-heptane; ester-based solvents such as ethyl acetate and butyl acetate; ether-based solvents such as tetrahydrofuran; ketone-based solvents such as acetone; aromatic solvents such as toluene and xylene; and alcoholic solvents such as methanol, ethanol, propyl alcohol and isopropyl alcohol. Also, examples of the wax can include polyethylene wax, synthetic paraffin, natural paraffin, microwax and chlorinated hydrocarbons. Also, examples of the oil can include lubricant oil, hydraulic oil, heat transfer oil and silicone oil.

As a method for applying the basic compound to the copper member 210, there may be used any method of immersing the copper member 210 in the basic compound or a solvent including the basic compound, applying the basic compound to the copper member 210 with a brush, or spraying the basic compound or a solution obtained by dissolving the basic compound in a solvent to the copper member 210. It is also possible to control the amount of the basic compound to be applied by air knife method or roll drawing method and to make the appearance and film thickness uniform after the application treatment with a squeeze coater, immersion treatment or spraying treatment. When the basic compound is applied, treatment such as warming or compression can be applied according to need in order to improve the adhesiveness and corrosion resistance.

As a method for applying the acidic compound to the copper member 210 after application of the basic compound, a method which is similar to that for applying the basic compound to the copper member 210 can be used.

After execution of the step of applying the basic compound to the copper member 210, the step of washing off the excessively-applied basic compound with a known solvent may be carried out. Also, after execution of the step of applying the acidic compound to the copper member 210, the step of washing off the excessively-applied acidic compound with a known solvent may be carried out.

In order to promote the chemical reaction between the basic group of the basic compound and the acidic group of the acidic compound, ultrasonic irradiation may be applied, or the acidic compound or acidic compound solution may be stirred by a known stirring device.

(Production Process)

Next, one example of the production process according to the present embodiment will be indicated. In the meantime, the production processes are not limited to those described below.

First, a copper member 210 is formed by pressing a plate material including a copper alloy into a predetermined shape. Next, a metal member 211 is formed by pressing a plate material including an aluminum alloy into a predetermined shape.

Then, the copper member 210 is immersed in a liquid obtained by dissolving a basic compound in a solvent, and then air-dried at room temperature.

Then, the copper member 210 is immersed in a liquid obtained by dissolving an acidic compound in a solvent. At this time, ultrasonic irradiation may be applied, or the acidic compound solution may be stirred by a known stirring means. Also, heating may be carried out in order to promote a reaction between the basic and acidic groups.

Then, the copper member 210 is air-dried at room temperature, thereby forming a water resistant layer 213 on the surface of the copper member 210.

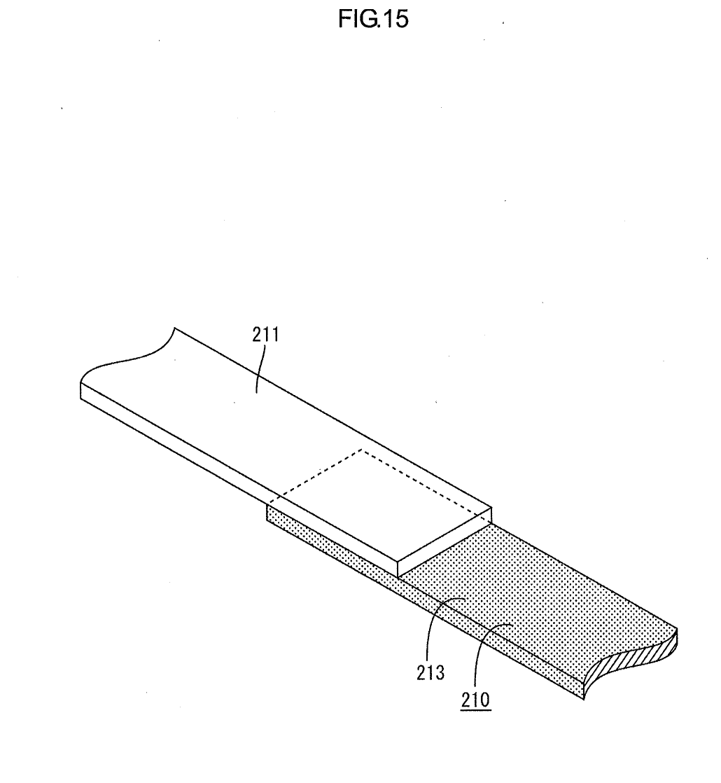

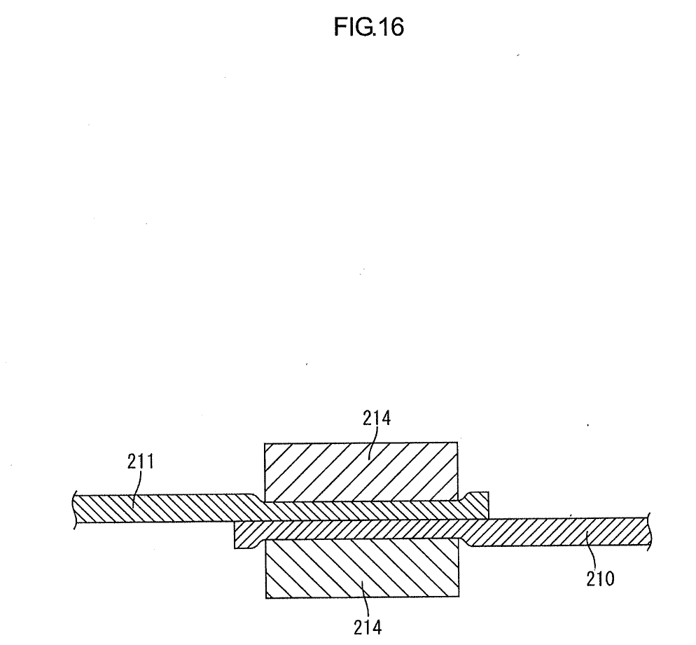

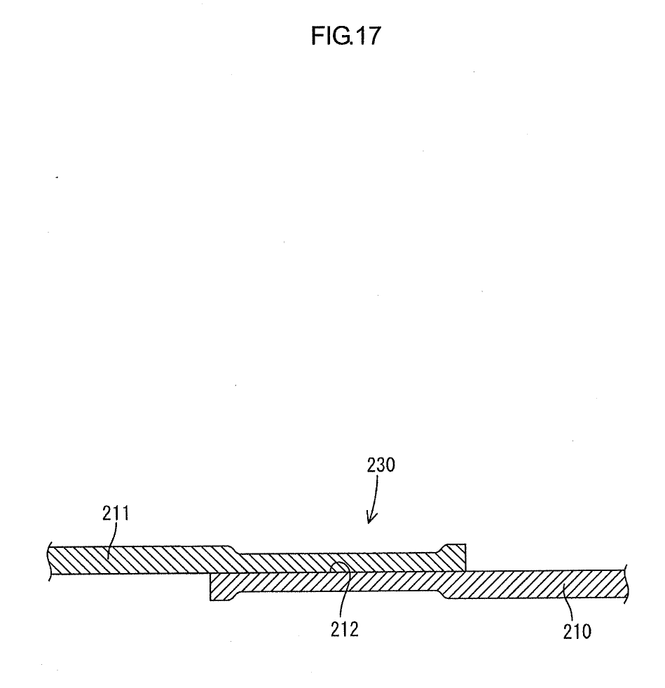

Subsequently, the copper member 210 and the metal member 211 are laminated as shown in FIG. 15, and then nipped between a pair of jigs 214 as shown in FIG. 16, thereby welding the copper member 210 and the metal member 211. In FIG. 15, the water resistant layer 213 is shown in a hatched manner. This allows for electric connection between the copper member 210 and the metal member 211 (see FIG. 17). At this time, in the connection part 212 where the copper member 210 and the metal member 211 are connected, high pressure is applied by the jigs 214, so that the surface treating agent is eliminated from the connection part 212. Thus, the water resistant layer 213 is not interposed between the copper member 210 and the metal member 211, thereby improving the reliability of electric connection between the copper member 210 and the metal member 211.

(Functions and Effects of the Present Embodiment)

Next, functions and effects of the present embodiment will be explained. As shown in FIG. 14, in the electric connection structure 230 according to the present embodiment, the water resistant layer 213 is formed at least in a portion of the surface of the copper member 210 (all the surfaces that are exposed to the outside, including the upper, lower and side surfaces) different from the connection part 212 connected to the metal member 211. Thus, when water 215 is deposited over both of the copper member 210 and the metal member 211, direct contact between the copper member 210 and the water 215 is suppressed by the water resistant layer 213 formed on the copper member 210.

Since the water resistant layer 213 is not formed in the connection part 212 according to the present embodiment, the deterioration in reliability of electric connection between the copper member 210 and the metal member 211 can be suppressed.

Also, according to the present embodiment, the acidic compound contained in the water resistant layer 213 has a hydrophobic group. Thus, even when water is deposited over both of the copper member 210 and the metal member 211, the water deposited on the water resistant layer 213 is less likely to reach the copper member 210 can be suppressed. Thus, direct contact between the copper member 210 and water is suppressed. Then, the supply of the dissolved oxygen contained in the water 215 to the copper member 210 is suppressed. This configuration suppresses a reaction in which the dissolved oxygen accepts electrons from the copper member 210, generates H₂O or OH⁻ ions, and causes consumption of electrons is suppressed. As a result of this, formation of a circuit via the water 215 between the copper member 210 and the metal member 211 is suppressed, thereby making it possible to suppress flow of corrosion current among the metal member 211, water 215 and the copper member 210. According to the present embodiment, the corrosion resistance of the metal member 211 can be improved by the configuration wherein the water resistant layer 213 is formed on the copper member 210 connected to the metal member 211, not on the metal member 211.

Also, the basic compound contained in the water resistant layer 213 has an affinity group. This affinity group has affinity for the copper member 210, so that the basic compound can be firmly bound to the surface of the copper member 210. Since the basic group of this basic compound reacts with the acidic group of the acidic compound, the basic and acidic compounds are firmly bound to each other. Thus, the hydrophobic group contained in the acidic compound is firmly bound to the copper member via the basic compound. In this manner, the copper member 210 and water resistant layer 213 can be firmly bound to each other according to the present embodiment, thereby making it possible to suppress separation of the water resistant layer 213 from the copper member 210. As a result of this, the corrosion resistance of the metal member 211 can be improved.

Also, according to the present embodiment, the water resistant layer 213 covers a portion of the copper member 210 different from the connection part 212. Thus, deposition of water on the surface of the copper member 210 can reliably be suppressed, thereby making it possible to reliably improve the corrosion resistance of the metal member 211. Also, increase in electric resistance between the copper member 210 and the metal member 211 in the connection part 212 can be suppressed.

### Second Embodiment (2)

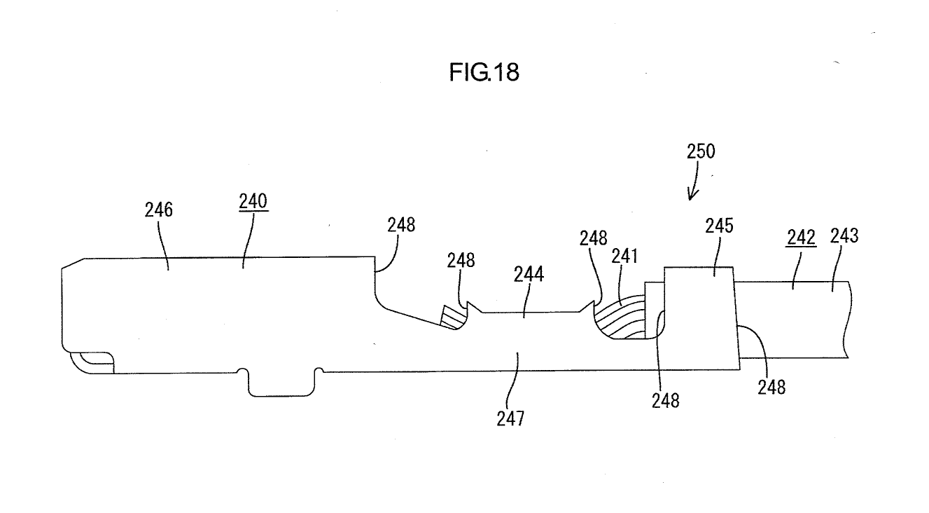

Next, a second embodiment (2) of the present invention will be explained with reference to FIGS. 18 to 21. The present embodiment is a wire with a terminal 250, which includes: a terminal 240 including copper or a copper alloy (corresponding to the copper member); and a wire 242 which is provided with a core wire 241 including a metal having an ionization tendency greater than that of copper (corresponding to the metal member). In the meantime, the explanation of the parts overlapping with those in the second embodiment (1) will be omitted.

(Wire 242)

The wire 242 is configured such that the outer periphery of the core wire 241 is enclosed with an insulating cover 243 made of a synthetic resin. Examples of the metal which constitutes the core wire 241 can include metals having an ionization tendency greater than that of copper, such as magnesium, aluminum, manganese, zinc, chromium, iron, cadmium, cobalt, nickel, tin and lead or alloys thereof. In the present embodiment, the core wire 241 includes aluminum or an aluminum alloy. The core wire 241 according to the present embodiment is a stranded wire obtained by twisting a plurality of fine metal wires together. The core wire 241 may be a so-called single core wire made of a metal bar material. The wire with a terminal 2153 can be reduced in weight as a whole because aluminum or an aluminum alloy has a relatively small specific weight.

(Terminal 240)

As shown in FIG. 18, the terminal 240 has: a wire barrel part 244 connected to the core wire 241 that is exposed from the terminal of the wire 242; an insulation barrel part 245 which is formed on the back side of the wire barrel part 244 to hold the insulating cover 243; and a main body part 246 which is formed on the front side of the wire barrel part 244 and into which a tab (not shown) of a male terminal is to be inserted.

The terminal 240 is formed by pressing a metal plate material made of copper or a copper alloy into a predetermined shape. The front and rear surfaces of the terminal 240 each have a plated layer 247 which is plated with a plating metal having an ionization tendency that is closer to that of the copper than to that of aluminum. Examples of usable plating metals include zinc, nickel and tin. In the present embodiment, tin is used as the plating metal since the contact resistance between the core wire and the wire barrel part can be reduced.

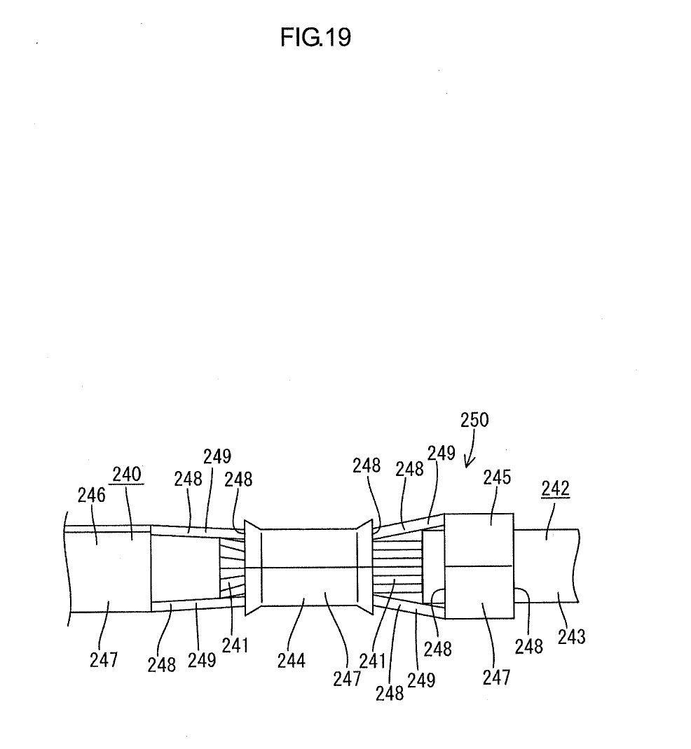

As shown in FIG. 19, copper or a copper alloy is exposed on end surfaces 248 of the terminal 240. Each end surface 248 has a water resistant layer 249 formed thereon. In the present embodiment, the water resistant layer 249 is formed at least on the end surface 248 of the wire barrel part 244. Also, the core wire 241 is exposed from the wire barrel part 244 on the front and back sides of the wire barrel part 244.

The above-described water resistant layer 249 can be formed, for example, by crimping the terminal 240 to the wire 242 and, thereafter, immersing at least the terminal 240 and the core wire 241 exposed from the wire 242 in a basic compound or basic compound solution, immersing them in an acidic compound or acidic compound solution, and drying them.

(Functions and Effects of the Present Embodiment)

The terminal 240 is formed by pressing a plate material made of a copper member into a predetermined shape. Therefore, the copper or copper alloy which constitutes the plate material is exposed on the end surface 248 of the wire barrel part 244 after pressing, regardless of whether the plate material is plated or not. In the state where copper or a copper alloy is exposed on the end surface 248 of the wire barrel part 244, water is deposited here, and thus electric erosion may be promoted due to the difference in ionization tendency from aluminum or an aluminum alloy contained in the core wire 241, leading to the elution of aluminum from the core wire 241.

Also, in the case where the plated layer 247 is peeled and therefore the copper member is exposed when the core wire 241 is crimped, aluminum may be eluted from the core wire 241 by electric erosion due to deposition of water on the exposed copper member.

In light of this point, the water resistant layer 249 is formed at least on the end surface 248 of the wire barrel part 244 in the present embodiment, and, hence, no copper or copper alloy is exposed on the end surface 248 of the wire barrel part 244. Thus, electric erosion of the core wire 241 can be suppressed.

Also, the water resistant layer 249 is formed on the end surface 248 of the terminal 240, so that electric erosion of the core wire 241 can further be suppressed.

Also, in the present embodiment, the water resistant layer 249 is formed after crimping of the core wire 241. Thus, even if the plated layer 247 is peeled when the core wire 241 is crimped, the water resistant layer 249 can be formed on the surface of the exposed copper member. Thus, electric erosion of the core wire 241 can be reliably suppressed.

Further, according to the present embodiment, the copper member has the plated layer 247 which is plated with a plating metal (tin in the present embodiment) having an ionization tendency that is closer to that of the copper member than to that of the metal member, and the water resistant layer 249 is formed at least in a region of the copper member where the plated layer 247 is not formed. Thus, the differences in ionization tendency between the core wire 241 and the plated layer 247 and between the copper member of the terminal 240 and the plated layer 247 are smaller than that between the core wire 241 and the copper member. Thus, electric erosion of the core wire 241 is less likely to occur, thereby improving electric erosion resistance.

(Corrosion Resistance Test)

Next, a model experiment according to the electric connection structure of the present invention will be explained. This model experiment has demonstrated that the formation of the water resistant layer 249 on the copper member improves the corrosion resistance of the metal member.

### Test Example 11

The above-described terminal 240 was formed by pressing a metal plate material made of the copper member including a copper alloy having a thickness of 0.25 mm. The core wire 241, made of an aluminum alloy and having a cross sectional area of 0.75 mm², of the wire 242 was crimped to the wire barrel part 244 of this terminal 240. Thus, the wire with a terminal 250 was formed.

The terminal 240 and core wire 241 of the wire with a terminal 250 were immersed in an aqueous solution of 1% by mass benzotriazole BT-120 (manufactured by JOHOKU CHEMICAL CO., LTD.) as a basic compound, with stirring, at 50° C. for 5 minutes, and then air-dried at room temperature. Thereafter, they were immersed in water having a temperature of 20° C. for 10 seconds, and then air-dried at 80° C. for 3 hours.

Then, the terminal 240 and core wire 241 were immersed in a phosphate compound (Cheleslite P-18C manufactured by CHELEST CORPORATION) as an acidic compound, with ultrasonic stirring, at 50° C. for 5 minutes, and then air-dried at room temperature.

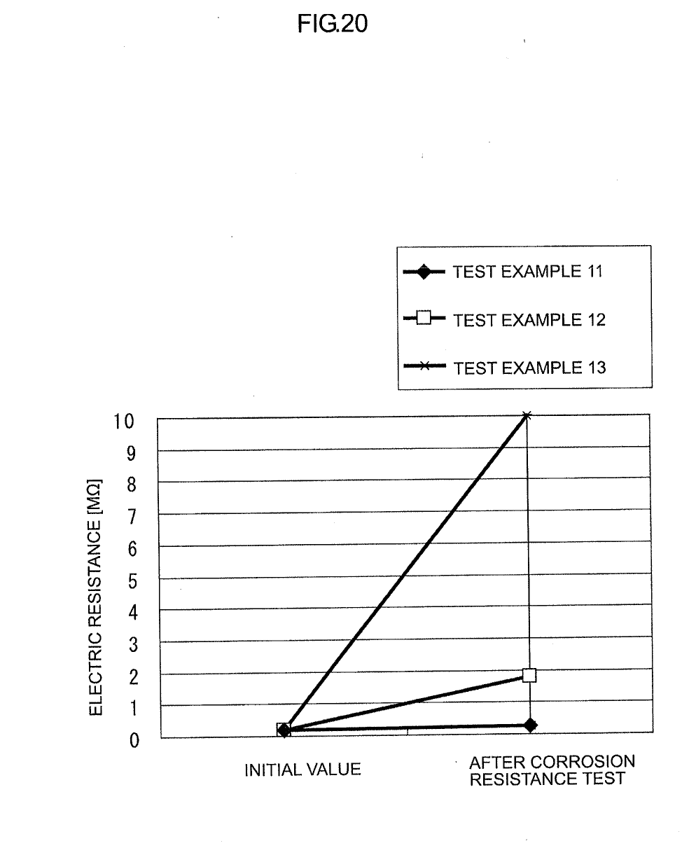

A salt spray test was conducted on the thus-prepared wire with a terminal 250 in conformity to JIS Z2371. The concentration of salt water was defined as 5.0% by mass. While this salt water was sprayed, the test was conducted until development of corrosion of the core wire in Test Example 13 which will be described below. Then, the electric resistance between the terminal 240 and the core wire 241 was investigated for the wire with a terminal 250. The result is summarized in Table 4, and a graph is shown in FIG. 20.

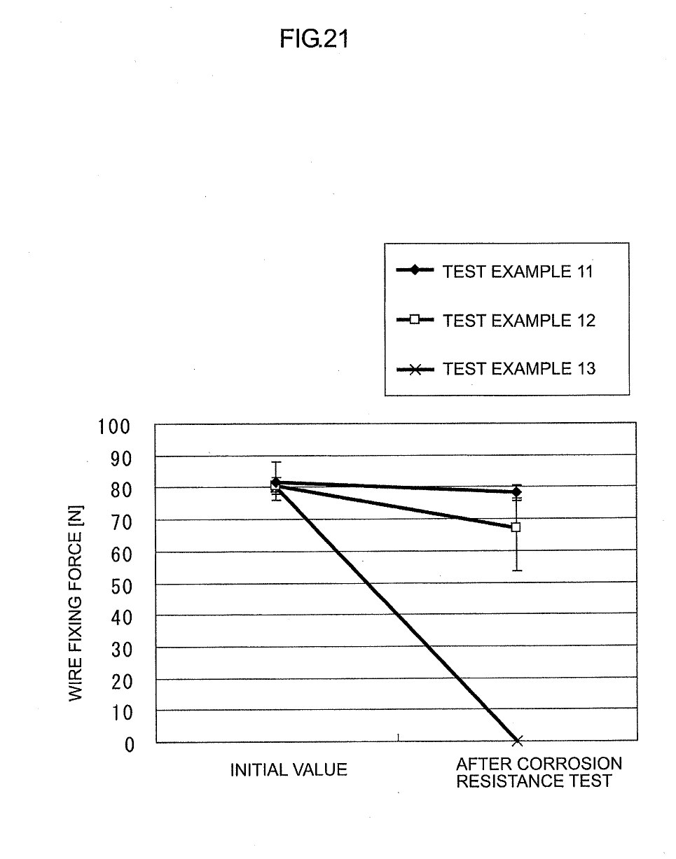

Then, a tensile test was conducted on the wire with a terminal 250. The tension speed was defined as 100 mm/min. The result is summarized in Table 4, and a graph is shown in FIG. 21.

### Test Example 12

The wire with a terminal 250 was formed in a similar manner as in Test Example 11, except that the step of immersing the wire with a terminal 250 in the basic compound solution was not carried out, and that only the step of immersing it in the acidic compound solution was carried out. The electric resistance between the terminal 240 and the core wire 241 was investigated for this wire with a terminal 250 according to Test Example 12, and a tensile test was conducted thereon. The results are summarized in Table 4, and graphs are shown in FIGS. 20 and 21.

### Test Example 13

The wire with a terminal 250 was formed in a similar manner as in Test Example 11, except that neither the step of immersing the wire with a terminal 250 in the basic compound solution nor the step of immersing it in the acidic compound solution was carried out. The electric resistance between the terminal 240 and the core wire 241 was investigated for this wire with a terminal 250 according to Test Example 13, and a tensile test was conducted thereon. The results are summarized in Table 4, and graphs are shown in FIGS. 20 and 21.

TABLE 4

| | Electric Resistance/mΩ | | Wire Fixing Force/N | |
|---|---|---|---|---|
| | Initial Value | After Test | Initial Value | After Test |
| Test Example 11 | 0.19 | 0.26 | 81.64 | 78.42 |
| Test Example 12 | 0.19 | 1.80 | 80.44 | 67.06 |
| Test Example 13 | 0.20 | 10.00 | 80.00 | 0.00 |

In the present embodiment, Test Example 11 is defined as a working example, and Test Examples 12 and 13 are defined as comparative examples. In Test Example 11, the electric resistance between the terminal 240 and the core wire 241 was 0.19 mΩ before the salt spray test, and 0.26 mΩ after the test. In this manner, the electric resistance value after the salt spray test was hardly increased from that before the test in Test Example 11.

Also, the wire fixing force before the salt spray test was 81.64 N, and that after the test was 78.42 N. In this manner, the wire fixing force after the salt spray test was hardly decreased from that before the test in Test Example 11.

On the other hand, in Test Example 12, the electric resistance between the terminal 240 and the core wire 241 was 0.19 mΩ before the salt spray test, but 1.80 mΩ after the test, which exhibited a 9.5-fold increase from that before the test. This is considered to be because the effect of suppressing corrosion current was obtained by the deposition of the phosphate compound on the surface of the copper member, but was not satisfactory. As a result of this, electric erosion of the core wire 241 caused formation of a slight gap between the core wire 241 and the wire barrel part 244, so that the electric resistance between the terminal 240 and the core wire 241 would be increased.

Also, the wire fixing force before the salt spray test was 80.44 N, and that after the test was 67.06 N, which showed a 16.6% reduction with respect to the electric resistance value before the test. This is considered to be because electric erosion of the core wire 241 caused formation of a slight gap between the core wire 241 and the wire barrel part 244, leading to reduction in fixing force.

Further, in Test Example 13, the electric resistance between the terminal 240 and the core wire 241 was 0.20 mΩ before the salt spray test, but 10.00 mΩ after the test, which exhibited a 50.0-fold increase from that before the test. This is considered to have been caused by electric erosion of the core wire.

Also, the wire fixing force before the salt spray test was 80.00 N, and that after the test was 0.00 N. This is considered to be because the wire barrel part 244 could not hold the core wire 241 due to electric erosion of the core wire 241.

As described above, the water resistant layer 249 is formed on the surface of the terminal 240 including the copper member, thereby making it possible to improve the corrosion resistance of the core wire 241 including the metal member.

In the present embodiment, the hydrophobic group is an alkyl group having 3 or more carbon atoms. Thus, arrival of water at the surface of the copper member of the terminal 40 can reliably be suppressed.

Also, in the present embodiment, the core wire 241 includes aluminum or an aluminum alloy. The wire with a terminal 250 can be reduced in weight because aluminum or an aluminum alloy has a relatively small specific weight.

Further, in the present embodiment, the affinity group is a nitrogen-containing heterocyclic group. Since the nitrogen-containing heterocyclic group has basicity, elution of the terminal 240 or core wire 241 through a reaction with the affinity group can be suppressed when the affinity group has acidity.

Also, in the present embodiment, the nitrogen-containing heterocyclic group serves also as the basic group. Thus, the structure of the basic compound can be simplified as compared with the case where the basic compound has a basic functional group in addition to the nitrogen-containing heterocyclic group.

Also, in the present embodiment, the basic compound is a compound represented by the following general formula (3):

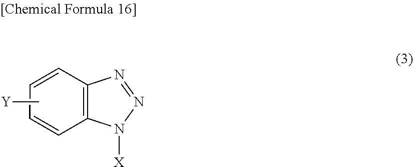

wherein X represents a hydrogen atom or an organic group; and Y represents a hydrogen atom or a lower alkyl group.

Thus, a dense layer of the basic compound can be formed on the surface of the copper member exposed from the end surface 248 of the terminal 240. Thus, the deposition of water on the surface of the copper member can reliably be suppressed.

For example, when the basic compounds have substituents having a relatively long carbon chain, the substituents interfere with each other, so that the basic compounds cannot densely gather on the surface of the copper member to be deposited thereon. Therefore, relatively coarse layers of the basic compounds may be formed on the surface of the copper member, and then water may arrive at the surface of the copper member through the gaps in the basic compound layers. According to the present embodiment, the basic compound is defined as a benzotriazole. Thus, the structure of the basic compound can be simplified. Thus, dense basic compound layers can be formed on the surface of the copper member. As a result of this, deposition of water on the surface of the copper member can reliably be suppressed.

Also, according to the present embodiment, the acidic group preferably includes one group or two or more groups selected from the group consisting of a carboxyl group, a phosphate group, a phosphonic acid group and a sulfonyl group. Thus, the basic compound and the acidic compound can reliably be reacted with each other.

### Second Embodiment (3)

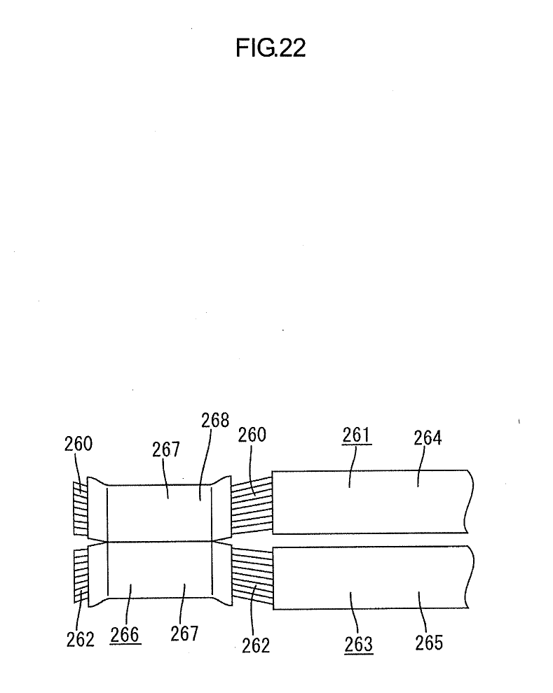

Next, a second embodiment (3) of the present invention will be explained with reference to FIG. 22. The present embodiment is configured such that a copper wire 261 which is provided with a copper core wire 260 including a copper member made of copper or a copper alloy and an aluminum wire 263 which is provided with an aluminum core wire 262 (corresponding to the core wire) made of a metal member including aluminum or an aluminum alloy having an ionization tendency greater than that of copper are connected to each other. The outer periphery of the copper core wire 260 is covered with the insulating cover 264 made of a synthetic resin, and the outer periphery of the aluminum core wire is covered with an insulating cover 265 made of a synthetic resin. In the meantime, the explanation of the parts overlapping with those in the second embodiment (1) will be omitted.

In the present embodiment, the copper core wire 260 and the aluminum core wire 262 are electrically connected by a splice terminal 266. The splice terminal 266 has a wire barrel part 267 to be crimped so as to be wound both around the copper core wire 260 and around the aluminum core wire 262.

The metal for the splice terminal 266 can be appropriately selected from any metals, according to need, including copper, copper alloys, aluminum, aluminum alloys, iron and iron alloys. The surface of the splice terminal 266 may have a plated layer (not shown) which is plated with a plating metal having an ionization tendency that is closer to that of copper than to that of aluminum. Examples of usable plating metals include zinc, nickel and tin.

The copper core wire 260, aluminum core wire 262 and splice terminal 266 are immersed in the basic compound and thereafter in the acidic compound, whereby a water resistant layer 268 is formed on the surfaces of the copper core wire 260, aluminum core wire 262 and splice terminal 266. Thus, the elution of the aluminum core wire 262 by electric erosion can be suppressed.

In the meantime, the copper core wire 260 and aluminum core wire 262 are not limited to the case where they are connected by the splice terminal 266. For example, the copper core wire 260 and aluminum core wire 262 can be connected by any technique such as resistance welding, ultrasonic welding, cold welding or crimping by heating, according to need.

### Other Embodiments

The present invention is not limited to the embodiments explained in the above description and drawings, and, for example, the following embodiments fall within the technical scope of the present invention.

(1) The surface treatment layer 13 is formed on the metal member 11 in the first embodiment (1), but the present invention is not limited thereto. For example, the present invention may be configured such that, after connection between the copper member 10 and the metal member 11, they are treated with a surface treating agent to form the surface treatment layer 13 on both the copper member 10 and on the metal member 11.

(2) The surface treatment step is carried out before application of the punching step to the metal plate material 101 in the first embodiment (2), but can be carried out, for example, in the following way. When the punching step is applied to the metal plate material 101, the surface treating agent may be mixed in a lubricant oil to carry out the surface treatment step. Also, when the bending process is applied to the terminal piece 110A, the surface treating agent may be mixed in a lubricant oil to carry out the surface treatment step. Also, after the crimping step, the terminal 110 may be immersed in the surface treating agent to carry out the surface treatment step.

(3) The alumite layer may be omitted in the first embodiment (2).

(4) The plated region 106 may be omitted in the first embodiment (2).

(5) The electric connection structure can be applied to any electric connection structures. Especially, the electric connection structure can be suitably used as an electric connection structure in a vehicle such as an automobile. For example, the electric connection structure can be applied to any electric connection structures, according to need, such as a connection structure between a wire including a copper member and a vehicle body including a metal member, a connection structure between a male terminal including a copper member and a female terminal including a metal member, a connection structure between a male terminal including a metal member and a female terminal including a copper member, and a connection structure between a bus bar including a copper member and a bus bar including a metal member.

(6) Not all the portions of the copper member that are different from the connection part may be covered with the water resistant layer.

(7) In the present embodiment, tin is used as a plating metal which constitutes the plated layer, but the present invention is not limited thereto. As the plating metal which constitutes the plated layer, any metal such as nickel and zinc can be selected according to need.

(8) The electric connection structure can be applied to any electric connection structures. Especially, the electric connection structure can be suitably used as an electric connection structure in a vehicle such as an automobile. For example, the electric connection structure can be applied to any electric connection structures, according to need, such as a connection structure between a wire including a copper member and a vehicle body including a metal member, a connection structure between a male terminal including a copper member and a female terminal including a metal member, a connection structure between a male terminal including a metal member and a female terminal including a copper member, and a connection structure between a bus bar including a copper member and a bus bar including a metal member.

### EXPLANATION OF REFERENCE NUMERALS

10, 21: Copper member
11, 20: Metal member
12: Connection part
13: Surface treatment layer
30: Electric connection structure
101: Metal plate material
104: Metal region
105: Copper region
106: Plated region
150: Terminal (copper member)
151: Core wire (metal member)
155: Wire barrel part
170: Copper core wire (first core wire)
171: Copper wire (first wire)
172: Aluminum core wire (second core wire)
173: Aluminum wire (second wire)
210: Copper member
211: Metal member
213, 249, 268: Water resistant layer
230: Electric connection structure
247: Plated layer
240: Terminal
242: Wire
260: Copper core wire
262: Aluminum core wire

1. An electric connection structure comprising:
a copper member comprising copper or a copper alloy;
a metal member connected to the copper member and comprising a metal having an ionization tendency greater than that of copper; and
a water-resistant layer formed at least in a portion of the copper member different from a connection part connected to the metal member.

2. The electric connection structure according to claim 1, wherein the water-resistant layer is a surface treatment layer comprising a surface treating agent having a hydrophobic part and a chelate group in the molecular structure.

3. The electric connection structure according to claim 2, wherein the hydrophobic part comprises an alkyl group.

4. The electric connection structure according to claim 2, wherein the chelate group is derived from one chelate ligand or two or more chelate ligands selected from polyphosphate, amino carboxylic acid, 1,3-diketone, acetoacetic acid (ester), hydroxycarboxylic acid, polyamine, amino alcohol, aromatic heterocyclic bases, phenols, oximes, Schiff bases, tetrapyrroles, sulfur compounds, synthetic macrocyclic compounds, phosphonic acid and hydroxyethylidene phosphonic acid.

5. The electric connection structure according to claim 4, wherein the surface treating agent comprises a benzotriazole derivative of the following general formula (1) having the chelate group which is derived from the aromatic heterocyclic base in the molecular structure: 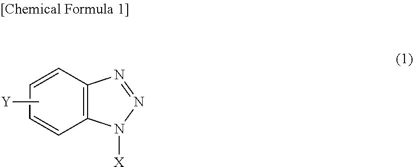
wherein X represents a hydrophobic group; and Y represents a hydrogen atom or a lower alkyl group.

6. The electric connection structure according to claim 5, wherein the hydrophobic group represented by the X is represented by the following general formula (2): 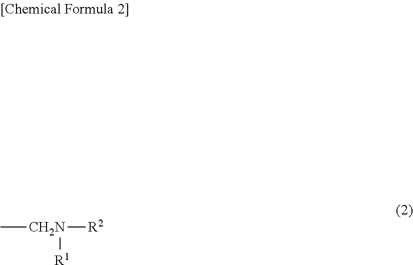
wherein R¹ and R² each independently represent a hydrogen atom or an alkyl group having 1 to 15 carbon atoms, a vinyl group, an allyl group or an aryl group.

7. The electric connection structure according to claim 6, wherein the R¹ and the R² each independently represent a linear alkyl group, a branched alkyl group or a cycloalkyl group having 5 to 11 carbon atoms.

8. The electric connection structure according to claim 5, wherein the Y is a hydrogen atom or a methyl group.

9. The electric connection structure according to claim 2, wherein the metal member comprises aluminum or an aluminum alloy.

10. The electric connection structure according to claim 2, wherein:
the copper member is a first core wire of a first wire; and
the metal member is a second core wire of a second wire which is different from the first wire.

11. The electric connection structure according to claim 2, wherein:
the metal member is a core wire of a wire;
the copper member is a terminal comprising a wire barrel part to be crimped to the core wire; and
the surface treatment layer is formed at least on an end surface of the wire barrel part.

12. A terminal comprising the electric connection structure according to claim 2, wherein:
the terminal is formed of a metal plate material in which the copper member and the metal member are cold-welded, and has a copper region comprising the copper member and a metal region comprising the metal member, which regions are aligned in juxtaposition; and
the surface treatment layer is formed in the copper region.

13. The terminal according to claim 12, wherein:
the copper region has a plated region which is plated with a plating metal having an ionization tendency that is closer to that of the copper member than to that of the metal member; and
the surface treatment layer is formed at least in a region of the copper member where the plated region is not formed.

14. The terminal according to claim 12, wherein:
the metal member comprises aluminum or an aluminum alloy; and
the metal region includes an alumite layer on a surface thereof.

15. The electric connection structure according to claim 1, wherein the water resistant layer comprises a basic compound having an affinity group with affinity for the copper member and a basic group, and an acidic compound having an acidic group to be reacted with the basic group and a hydrophobic group.

16. The electric connection structure according to claim 15, wherein the water resistant layer covers a portion of the copper member that is different from the connection part.

17. The electric connection structure according to claim 15, wherein:
the copper member has a plated layer which is plated with a plating metal having an ionization tendency that is closer to that of the copper member than to that of the metal member; and
the water resistant layer is formed at least in a region of the copper member where the plated layer is not formed.

18. The electric connection structure according to claim 15, wherein the affinity group is a nitrogen-containing heterocyclic group.

19. The electric connection structure according to claim 18, wherein the nitrogen-containing heterocyclic group serves as the basic group.

20. The electric connection structure according to claim 19, wherein the basic compound is a compound represented by the following general formula (3): 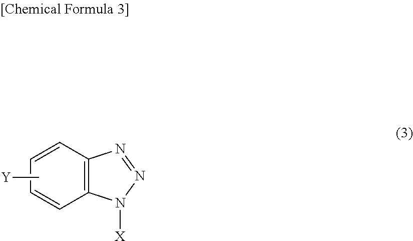
wherein X represents a hydrogen atom or an organic group; and Y represents a hydrogen atom or a lower alkyl group.

21. The electric connection structure according to claim 20, wherein the X is an amino group represented by the following general formula (4):
[Chemical Formula 4]
—R—NH₂ (4)
wherein R represents an alkyl group having 1 to 3 carbon atoms.

22. The electric connection structure according to claim 20, wherein the basic compound is a benzotriazole represented by formula (5):

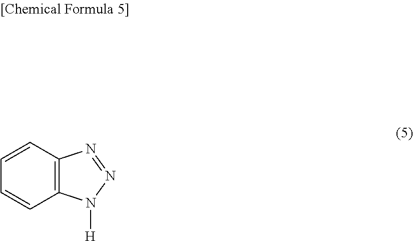

23. The electric connection structure according to claim 15, wherein the acidic group comprises one group or two or more groups selected from the group consisting of a carboxyl group, a phosphate group, a phosphonic acid group and a sulfonyl group.

24. The electric connection structure according to claim 15, wherein the hydrophobic group is an alkyl group having at least 3 carbon atoms.

25. The electric connection structure according to claim 15, wherein the metal member comprises aluminum or an aluminum alloy.

26. A terminal including the electric connection structure according to claim 15, wherein the terminal is made of the copper member and is connected to a core wire of a wire, the core wire being made of the metal member.
